(19) United States
(12) Patent Application Publication
(10) Pub. No.: US 2026/0129177 A1
(43) Pub. Date: May 7, 2026

(54) ELECTRONIC DEVICE FOR DISPLAYING STEREOSCOPIC SCREEN AND OPERATION METHOD THEREOF

(71) Applicant: Samsung Electronics Co., Ltd., Suwon-si (KR)

(72) Inventors: Jiin BAEK, Suwon-si (KR); Joayoung LEE, Suwon-si Gyeonggi-do (KR)

(21) Appl. No.: 19/438,890

(22) Filed: Jan. 2, 2026

Related U.S. Application Data
(63) Continuation of application No. PCT/KR2024/009187, filed on Jul. 1, 2024.

(30) Foreign Application Priority Data
Jul. 3, 2023 (KR) 10-2023-0085879
Jul. 14, 2023 (KR) 10-2023-0091961

(51) Int. Cl. H04N 13/398; G06F 3/0484; G06F 3/0485; H04N 13/128; H04N 13/305; H04N 13/31; H04N 13/383

(52) U.S. Cl. CPC H04N 13/398; G06F 3/0484; G06F 3/0485; H04N 13/128; H04N 13/305; H04N 13/31; H04N 13/383

(57) ABSTRACT

An electronic device may include: a three-dimensional display capable of displaying a stereoscopic screen/image; and at least one processor. When executed individually or collectively by the at least one processor, the instructions may cause the electronic device to: display the stereoscopic screen/image including an object on the three-dimensional display; acquire a user input corresponding to the object; identify, on the basis of at least one of the attributes of the object or the attributes of the user input, whether a designated response corresponding to the user input can be output; and move the object in the depth direction of the three-dimensional display on the basis of identifying that the designated response cannot be output.

### CROSS-REFERENCE TO RELATED APPLICATIONS

This application is a continuation of International Application No. PCT/KR2024/009187 designating the United States, filed on Jul. 1, 2024, in the Korean Intellectual Property Receiving Office and claiming priority to Korean Patent Application Nos. 10-2023-0085879, filed on Jul. 3, 2023, and 10-2023-0091961, filed on Jul. 14, 2023, in the Korean Intellectual Property Office, the disclosures of each of which are all incorporated by reference herein in their entireties.

### BACKGROUND

### Field

Certain example embodiments may relate to an electronic device including a three-dimensional display for displaying a stereoscopic screen and/or a method of operating the same according to an embodiment.

### Description of Related Art

With the development of technologies of electronic devices, various types of electronic devices such as mobile communication terminals, personal digital assistants (PDAs), electronic organizers, smartphones, tablet personal computers (PCs), and wearable devices have become widely used.

For example, the electronic device focuses on viewing images in which a three-dimensional effect is realized in a free location without cumbersome glasses of viewers, breaking away from the limitations of the existing 3D stereoscopic image method that requires wearing glasses. A three-dimensional display which displays glasses-free 3D stereoscopic images may fuse multi-view images into one, thereby providing different images to the left eye and the right eye using the viewer's eye time difference to provide an image in which a three-dimensional effect is realized.

Further, for example, the electronic device may provide virtual reality (VR) that allows the user to experience the real world in a virtual world created by a computer, augmented reality (AR) that adds virtual information (or objects) to the real world and shows the same, and mixed reality (MR) that mixes virtual reality and augmented reality. The electronic device provides 3D stereoscopic images corresponding to virtual reality, augmented reality, or mixed reality to the user.

The information may be provided as the related art to help understanding of the disclosure. Any opinion or decision on whether the above-mentioned content can be applied as the prior art related to the disclosure has been not provided.

### SUMMARY

An electronic device according to an example embodiment may include a three-dimensional (3D) display capable of displaying a stereoscopic screen and at least one processor comprising processing circuitry. The instructions, when executed individually or collectively by the at least one processor, may cause the electronic device to display the stereoscopic screen (e.g., stereoscopic image) including an object on the 3D display. The instructions, when executed individually or collectively by the at least one processor, may cause the electronic device to obtain a user's input corresponding to the object. The instructions, when executed individually or collectively by the at least one processor, may cause the electronic device to, based on a property of the object or a property of the user's input, provide feedback corresponding to the user's input to the object. The instructions, when executed individually or collectively by the at least one processor, may cause the electronic device to, as at least part of the providing the feedback to the object, change a sense of depth of the object according to a direction crossing a screen display area of the 3D display.

A method of operating an electronic device according to an example embodiment may include displaying the stereoscopic screen including an object on the 3D display. The method of operating the electronic device may include obtaining a user's input corresponding to the object included in the stereoscopic screen. The method of operating the electronic device may include, based on a property of the object or a property of the user's input, providing feedback corresponding to the user's input to the object. In the method of operating the electronic device, the providing of the feedback to the object may include changing a sense of depth of the object according to a direction crossing a screen display area of the 3D display.

A non-transitory computer-readable storage medium storing one or more programs according to an example embodiment may include displaying a stereoscopic screen including an object on the 3D display, based on execution of an application. The storage medium according to an embodiment may include obtaining a user's input corresponding to the object. The storage medium according to an embodiment may include, based on a property of the object or a property of the user's input, providing feedback corresponding to the user's input to the object. In the storage medium according to an embodiment, the providing of the feedback to the object may include changing a sense of depth of the object according to a direction crossing a screen display area of the 3D display.

An electronic device according to an example embodiment may include a three-dimensional (3D) display capable of displaying a stereoscopic screen and at least one processor comprising processing circuitry. The instructions, when executed individually or collectively by the at least one processor, may cause the electronic device to display the stereoscopic screen including an object on the 3D display. At least part of the object may be displayed such that the sense of depth according to the direction crossing the screen display area of the 3D display is reduced than the screen display area. The instructions, when executed individually or collectively by the at least one processor, may cause the electronic device to obtain a user's input corresponding to the object included in the stereoscopic screen. The user's input may be a touch input and/or a proximity input generated corresponding to the screen display area. The instructions, when executed individually or collectively by the at least one processor, may cause the electronic device to, based on the user's input, change a property related to displaying of the object.

A method of operating an electronic device according to an example embodiment may include displaying the stereoscopic screen including an object on the 3D display. At least part of the object may be displayed such that the sense of depth according to the direction crossing the screen display area of the 3D display is reduced than the screen display area. The method of operating the electronic device according to an embodiment may include obtaining a user's input corresponding to the object included in the stereoscopic screen. The user's input may be a touch input and/or a proximity input generated corresponding to the screen display area. A method of operating an electronic device according to an embodiment may include changing a property related to displaying of the object, based on the user's input.

A computer-readable storage medium configured to store one or more programs according to an example embodiment may include displaying a stereoscopic screen including an object on the 3D display, based on execution of an application. At least part of the object may be displayed such that the sense of depth according to the direction crossing the screen display area of the 3D display is reduced than the screen display area. The storage medium according to an embodiment may include obtaining a user's input corresponding to the object. The user's input may be a touch input or a proximity input generated corresponding to the screen display area. The storage medium according to an embodiment may include changing a property related to displaying of the object, based on the user input.

A computer-readable storage medium storing instructions according to an example embodiment is provided. The instructions, when executed by at least one processor of an electronic device, may cause the electronic device to display a stereoscopic screen including an object on a 3D display capable of displaying the stereoscopic screen. The instructions, when executed by at least one processor of the electronic device, may cause the electronic device to obtain a user's input corresponding to the object. The instructions, when executed by at least one processor of the electronic device, may cause the electronic device to, based on a property of the object or a property of the user's input, provide feedback corresponding to the user's input to the object. The instructions, when executed by at least one processor of the electronic device, may cause the electronic device to, as at least part of the providing the feedback to the object, change a sense of depth of the object according to a direction crossing a screen display area of the 3D display.

### BRIEF DESCRIPTION OF THE DRAWINGS

FIG. 1 is a block diagram illustrating an electronic device in a network environment according to an example embodiment.

FIG. 2 is a block diagram of an electronic device according to an example embodiment.

FIG. 3A illustrates screens provided to the left eye and the right eye of a user, based on a left-right division method according to an example embodiment.

FIG. 3B is a screen recognized by the user according to a display screen of FIG. 3A.

FIG. 4 illustrates an object included in a stereoscopic screen corresponding to various senses of depth according to an example embodiment.

FIG. 5A illustrates a scheme using lenticular lenses according to an example embodiment.

FIG. 5B illustrates a scheme using parallax barriers according to an example embodiment.

FIG. 5C illustrates an embodiment of the electronic device which realizes virtual reality according to an example embodiment.

FIG. 5D illustrates an embodiment of the electronic device which realizes augmented reality according to an example embodiment.

FIG. 6A illustrates an embodiment of decreasing a sense of depth of an object according to a direction that crosses a screen display of a three-dimensional display according to an example embodiment.

FIG. 6B illustrates an embodiment of increasing the sense of depth of the object according to the direction that crosses the screen display of the three-dimensional display according to an example embodiment.

FIG. 6C illustrates an embodiment of gradually increasing the sense of depth of the object according to the direction that crosses the screen display area of the three-dimensional display according to an example embodiment.

FIG. 6D is a flowchart illustrating a fingerprint authentication operation of the electronic device according to an example embodiment.

FIG. 7 illustrates an embodiment of a user input for an inactive object according to an example embodiment.

FIGS. 8A, 8B, and 8C illustrate inactive objects according to various embodiments of the disclosure.

FIG. 8D illustrates an embodiment of changing a sense of depth of an object according to the direction that crosses the screen display area of the three-dimensional display according to an example embodiment.

FIG. 9 illustrates a user input for an unselectable object according to an example embodiment.

FIG. 10 illustrates a user input for an immovable object according to an example embodiment.

FIG. 11 illustrates a user input for an immovable or uncopiable object according to an example embodiment.

FIGS. 12A and 12B illustrate a user input for a home screen having a plurality of pages according to an example embodiment.

FIG. 13 illustrates a user input for a background screen according to an example embodiment.

FIGS. 14A and 14B illustrate a scrollable list according to an example embodiment.

FIG. 14C illustrates an embodiment of a user input for a scrollable list according to an example embodiment.

FIG. 15A illustrates scrollable contents according to an example embodiment.

FIG. 15B illustrates an embodiment of a user input for scrollable contents according to an example embodiment.

FIG. 16A illustrates a user input for a window of which movement or size change is limited according to an example embodiment.

FIGS. 16B and 16C illustrate various examples of FIG. 16A.

FIG. 17 illustrates a user input for a slider according to an example embodiment.

FIG. 18 illustrates a user movement input for an object according to an example embodiment.

FIG. 19 illustrates a user size change input for an object according to an example embodiment.

FIG. 20 illustrates a user end input for an object according to an example embodiment.

FIGS. 21A and 21B illustrate an embodiment of decreasing a sense of depth of an object according to a direction that crosses a screen display of a three-dimensional display according to an example embodiment.

FIG. 21C illustrates an embodiment of increasing the sense of depth of the object according to the direction that crosses the screen display area of the three-dimensional display according to an example embodiment.

FIG. 22 illustrates an embodiment of moving an object located in the positive direction along the direction that crosses the screen display area of the three-dimensional display according to an example embodiment.

FIGS. 23A and 23B illustrate an embodiment of applying a predetermined effect to an object located in the positive direction along the direction that crosses the screen display area of the three-dimensional display according to an example embodiment.

FIG. 24 illustrates an embodiment of moving an object located in the positive direction along the direction that crosses the screen display area of the three-dimensional display according to an example embodiment.

FIGS. 25A and 25B illustrate an embodiment of applying a visual effect to an object located in the positive direction along the direction that crosses the screen display area of the three-dimensional display according to an example embodiment.

FIG. 26 is a flowchart illustrating a method of operating the electronic device according to an example embodiment.

FIG. 27 is a flowchart illustrating a method of operating the electronic device according to an example embodiment.

### DETAILED DESCRIPTION

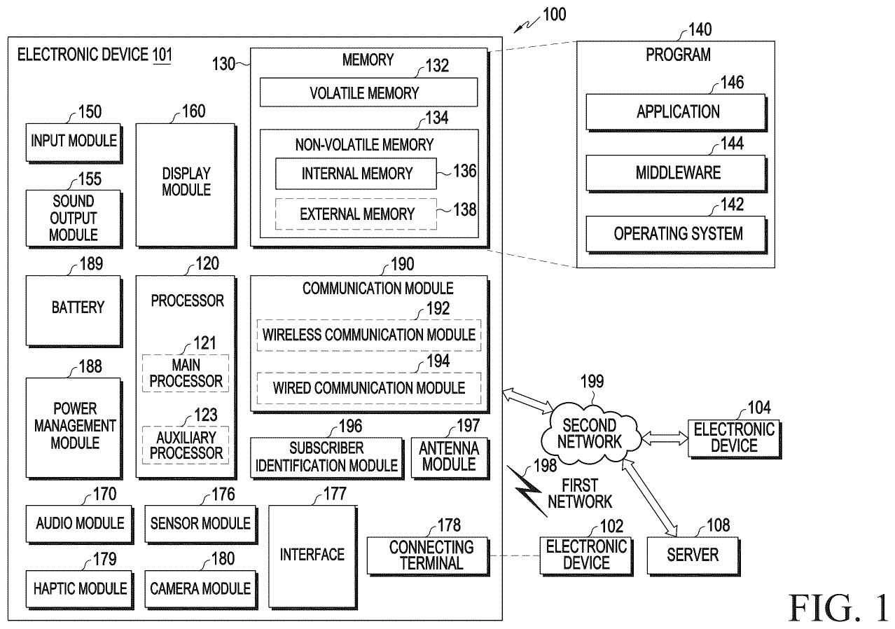

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120, comprising processing circuitry, may execute, for example, software (e.g., a program 140) to control at least one other component (e.g., a hardware or software component) of the electronic device 101 coupled with the processor 120, and may perform various data processing or computation. According to an example embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include one or more of a main processor 121 (e.g., a central processing unit (CPU) or an application processor (AP), of course comprising processing circuitry), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123, comprising processing circuitry, may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108, comprising processing circuitry). Learning algorithms may include, but are not limited to, e.g., supervised learning, unsupervised learning, semi-supervised learning, or reinforcement learning. The artificial intelligence model may include a plurality of artificial neural network layers, and may be trained and used, and may comprise circuitry. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an example embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

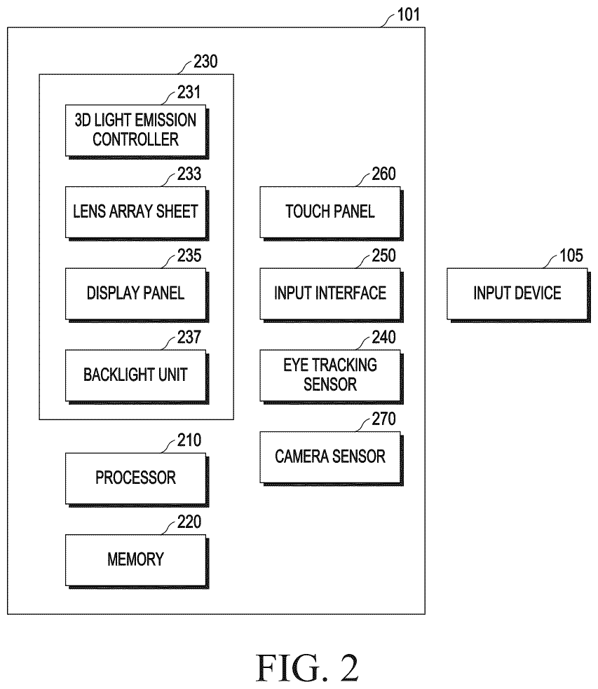

FIG. 2 is a block diagram of the electronic device 101 according to an example embodiment.

Referring to FIG. 2, the electronic device 101 according to an embodiment may include a processor 210 (for example, the processor 120 of FIG. 1, comprising processing circuitry), memory 220 (for example, the memory 120 of FIG. 1), a three-dimensional display 230 (for example, the display module 160 of FIG. 1), an eye tracking sensor 240 (for example, the sensor module 176 of FIG. 1), an input interface 250 (for example, the interface 166 of FIG. 1), a touch panel 260, and/or a camera sensor 270 (for example, the camera module 180 of FIG. 1). The electronic device 101 according to an embodiment may further include some components included in the electronic device 101 of FIG. 1 in addition thereto, or may be configured except for some components.

The processor 210 according to an embodiment may control at least one other component (for example, hardware or software components) of the electronic device 101. As an embodiment, the processor 210 may perform various data processing or calculations, and store commands or data received from other components in the memory 220, process the command or data stored in the memory 220, and store resultant data in the memory 220 as at least a part of the data processing or calculations.

As an embodiment, the processor 210 may be provided with a rendering engine that renders a three-dimensional screen to be displayed on the three-dimensional display 230 in real time. For example, the rendering engine may be included in a graphic processing unit (GPU) or a central processing unit (CPU).

The memory 220 according to an embodiment may store instructions executable in the processor 210.

The three-dimensional display 230 according to an embodiment may display a visual screen that implements stereoscopic vision to the user. As an embodiment, the three-dimensional display 230 may display a stereoscopic screen including an object. For example, the object may be a 3D object of which at least a part is displayed three-dimensionally. For example, the object may be located in a positive direction or a negative direction along a direction in which at least the part crosses a screen display area 235 of the three-dimensional display 230 and displayed three-dimensionally on the three-dimensional display 230.

As an embodiment, a 3D light emission controller 231, comprising circuitry, constructing a stereoscopic screen, based on a signal received from the processor 210 may be included in the three-dimensional display 230. As an embodiment, a display panel 235 configured to display a stereoscopic screen (e.g., of or including a stereoscopic image), a backlight unit 237 configured to provide backlight to the display panel 235, and a lens array sheet 233 disposed in front of the display panel 235 may be included in the three-dimensional display 230.

As an embodiment, the three-dimensional display 230 may display a stereoscopic screen (e.g., stereoscopic image) by displaying different images on user's right and left eyes according to a left-right division method as described below.

The eye tracking sensor 240 according to an embodiment may measure the location of user's eyes. As an embodiment, the eye tracking sensor 240 may use an RGB sensor or a depth sensor.

As an embodiment, the eye tracking sensor 240 may be an image sensor configured to directly detect the location of user's eyes (for example, left eye and right eye). As an embodiment, the eye tracking sensor 240 may be a location detection sensor configured to detect the location of a user's face, and the processor 210 may estimate the location of user's eyes, based on the location of the detected user's face.

The input interface 250 according to an embodiment may receive a user input corresponding to the stereoscopic screen displayed on the three-dimensional display 230. As an embodiment, the input interface 230 may receive an indirect control input through the input device 105 connected to the electronic device 101 or a user's direct control input acquired through a sensor (for example, the touch panel 260 or the camera sensor 270). As an embodiment, the input interface 250 may support a predetermined protocol for the connection with the external input device 105.

The touch panel 260 according to an embodiment may be integrally coupled to the three-dimensional display 230 and may detect a user's touch input corresponding to the stereoscopic screen displayed on the three-dimensional display 230. As an embodiment, the electronic device 101 may display a controller (for example, slider or coordinate) in at least a partial area of the three-dimensional display 230 and detect a user's touch input corresponding to the displayed controller. For example, the touch panel 260 may detect a touch, based on a principle such as a capacitive type, an electromagnetic type, a pressure type, or an infrared type, but is not limited thereto.

As an embodiment, the touch panel 260 may additionally detect a proximity touch that approaches or located near the touch panel 260 without any mechanical contact as well as a user's physical contact touch. For example, the touch panel 260 may detect a proximity touch, based on a principle such as a transmissive photoelectric sensor, a direct reflective photoelectric sensor, a mirror reflective photoelectric sensor, a high frequency oscillating proximity sensor, a capacitive proximity sensor, a magnetic proximity sensor, or an infrared proximity sensor, but is not limited thereto.

As an embodiment, when the capacitive type is used, the touch panel 260 may detect not only a user's contact touch but also a proximity touch of a point through a change in an electric field due to proximity of the point.

For example, a proximity sensor (for example, the sensor module 176 of FIG. 1) configured to detect a proximity sensor, based on a principle such as a transmissive photoelectric sensor, a direct reflective photoelectric sensor, a mirror reflective photoelectric sensor, a high frequency oscillating proximity sensor, a capacitive proximity sensor, a magnetic proximity sensor, or an infrared proximity sensor may be additionally disposed above or below the touch panel 260.

The camera sensor 270 according to an embodiment may detect a user's gesture generated in accordance with a screen display area of the three-dimensional display 230. As an embodiment, a gesture by a user's hand may be generated in front of the three-dimensional display 230 in accordance with the stereoscopic screen of the three-dimensional display 230, and the camera sensor 270 may detect the location and type of the user's gesture.

The camera sensor 270 according to an embodiment may detect a user's proximity input in proximity to the three-dimensional display 230.

The input device 105 according to an embodiment may be wiredly or wirelessly connected to the electronic device 101. For example, the input device 105 may be a controller that delivers a control input according to a stylus pen, a slider, or a coordinate. For example, the input device 105 may acquire an input such as movement, touch, button click, or hovering and provide a signal corresponding to the acquired input to the electronic device 101 (for example, the input interface 250).

The electronic device 101 according to an embodiment may move, enlarge, or change the stereoscopic screen (or object) displayed on the three-dimensional display 230, based on the user input acquired from the input interface 250 connected to the touch panel 260 or the camera sensor 270, or the external input device 101.

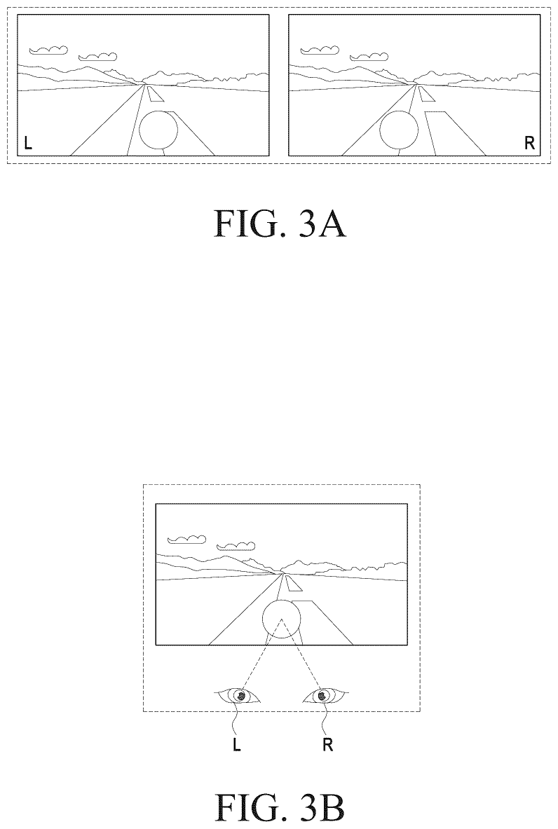

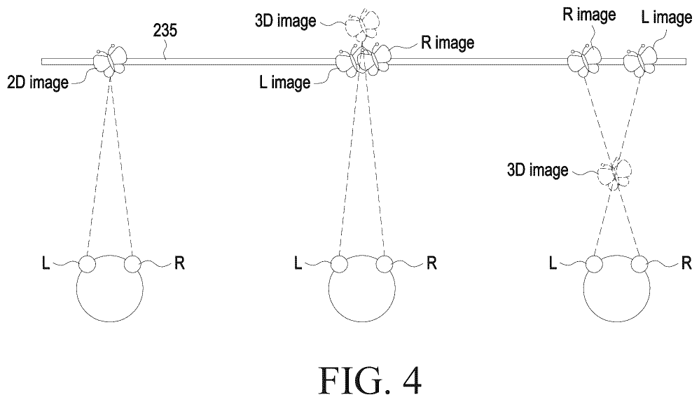

FIG. 3A illustrates screens provided to the left eye (L) and the right eye (R) of the user, based on a left-right division method according to an example embodiment. FIG. 3B is a screen recognized by the user according to the display screen of FIG. 3A. FIG. 4 illustrates an object (2D image or 3D image) included in a stereoscopic screen corresponding to various senses of depth according to an example embodiment.

Referring to FIGS. 3A, 3B, and 4, the electronic device 101 according to an embodiment may provide a stereoscopic screen according to a left-right division method using binocular parallax (disparity) through a three-dimensional display (for example, the three-dimensional display 230 of FIG. 2). As an embodiment, the electronic device 101 may use a left-right division method of differently displaying an image (L image) provided to the user's left eye (L) and an image (R image) provided to the user's right eye (R) to allow the user to recognize the stereoscopic screen. The user's brain may synthesize the image (L image) viewed through the left eye (L) and the image (R image) viewed through the right eye (R) to observe the stereoscopic image.

As an embodiment, the electronic device 101 may control the sense of depth of the object (2D image or 3D image) included in the stereoscopic screen felt by the user by controlling the relative location and the distance between the image (L) corresponding to the left eye (L) and the image (R image) corresponding to the right eye (R).

As an embodiment, the electronic device 101 may display a stereoscopic screen to allow the user to recognize that a two-dimensional object (2D image) has the sense of depth corresponding to the screen display area 235 of the three-dimensional display 230 by identically displaying the image (L image) corresponding to the left eye (L) and the image (R image) corresponding to the right eye (R).

As an embodiment, the electronic device 101 may display a stereoscopic screen to allow the user to recognize that a three-dimensional object (3D image) has the sense of depth located in the negative direction along a direction that crosses the screen display area 235 of the three-dimensional display 230 by moving the image (L image) corresponding to the left eye (L) to the left side and moving the image (R image) corresponding to the right eye (R) to the right side.

As an embodiment, the electronic device 101 may display a stereoscopic screen to allow the user to recognize that a three-dimensional object (3D image) has the sense of depth located in the positive direction along a direction that crosses the screen display area 235 of the three-dimensional display 230 by moving the image (L image) corresponding to the left eye (L) to the right side and moving the image (R image) corresponding to the right eye (R) to the left side.

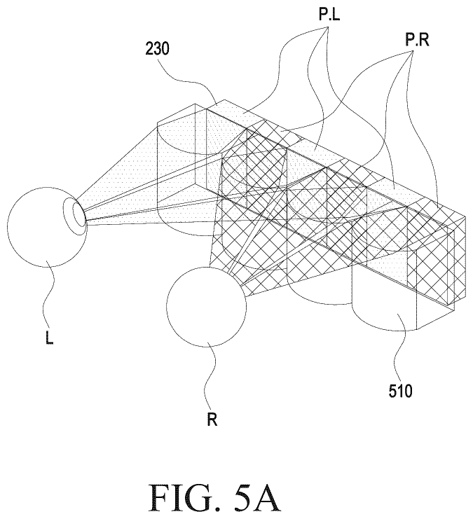

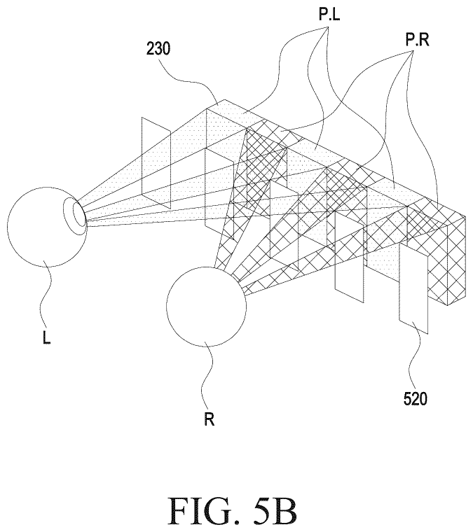

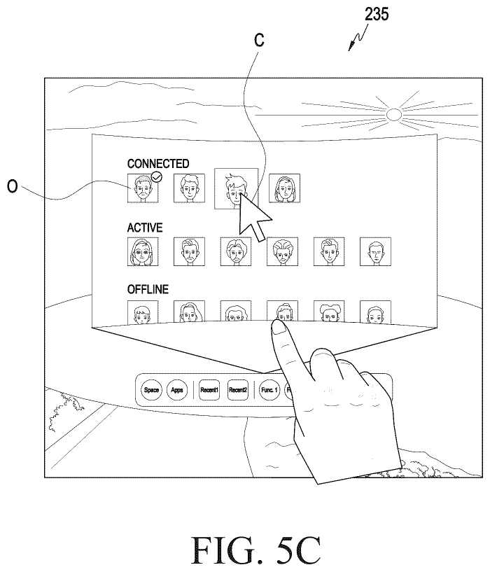

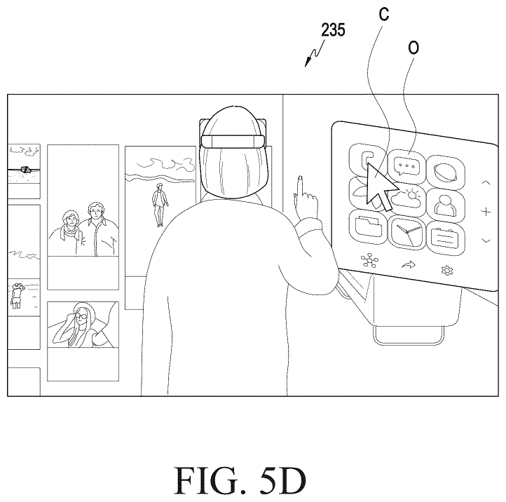

FIG. 5A illustrates a scheme using lenticular lenses 510 according to an example embodiment. FIG. 5B illustrates a scheme using parallax barriers 520 according to an example embodiment.

Referring to FIGS. 5A and 5B, the electronic device 101 may generate binocular parallax between the user's left eye (L) and right eye (R) to provide a stereoscopic screen according to a left-right division scheme.

The binocular parallax (stereo disparity) indicates the difference in the way a person's left eye (L) and right eye (R) see an object. When the user's brain synthesizes an image viewed through the left eye (L) and an image viewed through the right eye (R), the synthesized image makes the person have the stereoscopic effect. A stereoscopic image display method according to binocular parallax may be divided into a glass type that requires special glasses and a non-glass type that does not require glasses.

The glass type includes a scheme using color glasses having wavelength selectivity, a polarizing glass scheme using a shading effect, and a time division glass scheme that alternately presents left and right images within the eye afterimage time. In addition, there is a scheme of obtaining a stereoscopic effect for movement in the left and right directions according to the time difference in the visual system from the difference in transmittance by installing filters having different transmittance on the left and right eyes (L and R).

A glasses-free type corresponding to a type in which a three-dimensional effect is generated on the image display surface side rather than the observer side includes, for example, a parallax barrier type, a lenticular lens type, or a microlens array type.

As an embodiment, in the electronic device 101, lenticular lenses 510 may be disposed in front of the three-dimensional display 230 as illustrated in FIG. 5A. For example, the lenticular lenses 510 may be formed of a film or glass and attached to the front of the three-dimensional display 230. For example, in the three-dimensional display 230, pixels (P.L.) to be input into the left eye and pixels (P.R.) to be input into the right eye may be alternately arranged along the horizontal direction, and the lenticular lenses 510 may provide an optical differential directivity for the pixels (P.L.) to be input into the left eye and the pixels (P.R.) to be input into the right eye. As an embodiment, the three-dimensional display 230 may separate different screens by the lenticular lenses 510 located in front of the three-dimensional display 230 and provide the same to the left eye (L) and the right eye (R).

As an embodiment, in the electronic device 101, parallax barriers 520 may be disposed in front of the three-dimensional display 230 as illustrated in FIG. 5B. For example, parallax barriers 520 may be attached to the front of the three-dimensional display 230, and the electronic device 101 may control movement of the parallax barriers 520. For example, in the three-dimensional display 230, the pixels (P.L.) to be input into the left eye and the pixels (P.R.) to be input into the right eye may be alternately arranged along the horizontal direction, and the screen may be separately provided to the left eye (L) and the right eye (R) through aperture in the vertical grid shape. As an embodiment, three-dimensional display 230 may separate different screens by the parallax barriers 520 located in front thereof and provide the same to the left eye (L) and the right eye (R).

FIG. 5C illustrates an embodiment of the electronic device 101 that implements virtual reality according to an example embodiment. FIG. 5D illustrates an embodiment of the electronic device 101 that implements augmented reality according to an example embodiment.

Referring to FIGS. 5C and 5D, the electronic device 101 according to an embodiment may include a display (for example, the three-dimensional display 230 of FIG. 2) configured to directly provide the screen to the user's eyes. As an embodiment, the electronic device 101 may be formed in the form of glasses, and may induce the user to experience binocular parallax by separately including the display 230 corresponding to each of the left eye and the right eye of the user. As an embodiment, the electronic device 101 may provide a stereoscopic screen to the user by displaying different image or images for the user's left eye and right eye.

As an embodiment, the electronic device 101 may display a stereoscopic screen through the screen display area 235 of the display 230 for displaying the screen corresponding to each of both eyes of the user, and change the sense of depth according to a direction that crosses the screen display area 235 of the display 230 and display an object (O) included in the stereoscopic screen.

As illustrated in FIG. 5C, the electronic device 101 according to an embodiment may implement virtual reality (VR) through the screen display area 235 of the display 230. As an embodiment, the electronic device 101 may display a virtual object (O) in the screen display area 235 of the display 230.

As illustrated in FIG. 5D, the electronic device 101 according to an embodiment may implement augmented reality (AR) through the screen display area 235 of the display 230. As an embodiment, the electronic device 101 may expose an external environment to the user through the screen display area 235 of the transparent or translucent display 230. As an embodiment, the electronic device 101 may display the virtual object (O) in the screen display area 235 of the transparent or translucent display 230 to overlap the external environment.

As an embodiment, the electronic device 101 may detect motion of the user's hand through a camera sensor (for example, the camera sensor 270 of FIG. 2) or use an input interface (for example, the input interface 250 of FIG. 2) acquiring a user input by using movement of a cursor (C) through an input device (for example, the input device 105 of FIG. 2).

As an embodiment, the electronic device 101 may output a feedback based on attributes of the object (O) or attributes of the user input in response to the user input for the virtual object (O).

As an embodiment, in response to the user input for the virtual object (O), as feedback provided based on attributes of the object (O) or attributes of the user input, the electronic device 101 may change the sense of depth of the virtual object (O) according to the direction that crosses the screen display area 235 of the display 230.

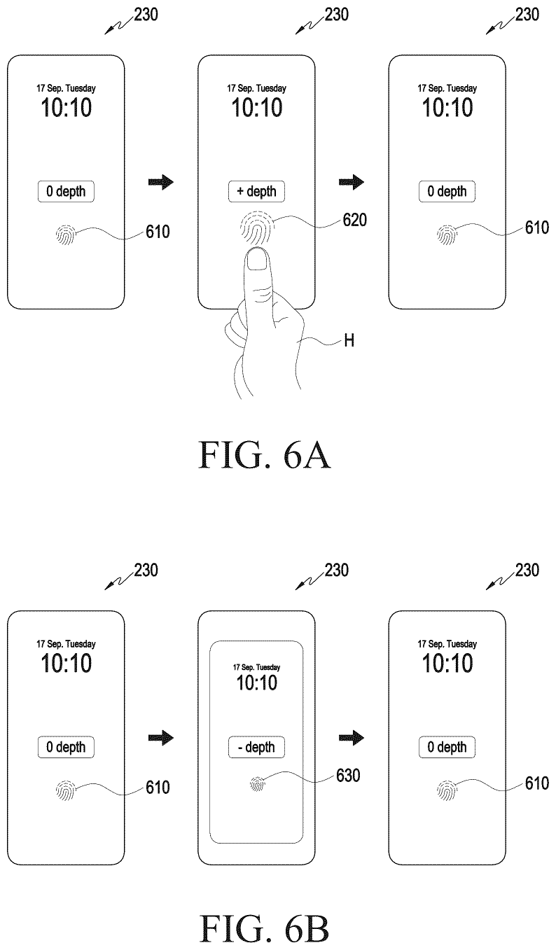

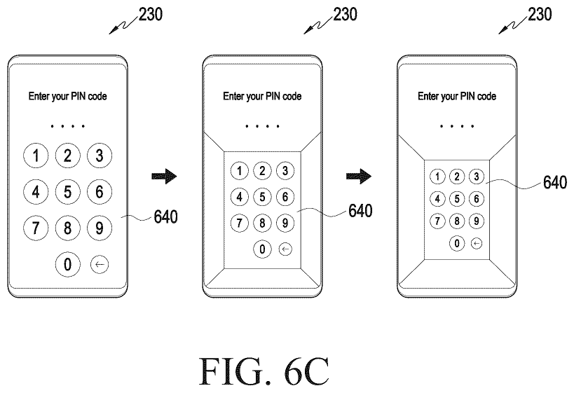

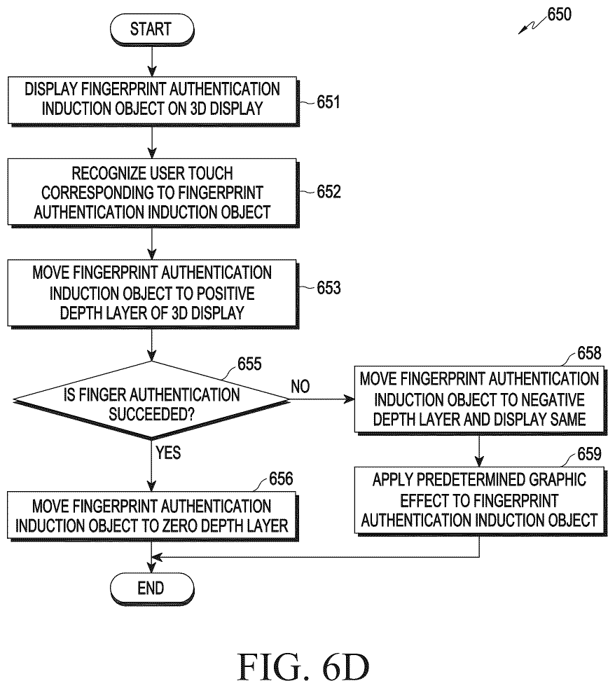

FIG. 6A illustrates an embodiment of decreasing a sense of depth of an object 610 according to a direction that crosses a screen display of a three-dimensional display according to an example embodiment. FIG. 6B illustrates an embodiment of increasing the sense of depth of the object 610 according to the direction that crosses the screen display area of the three-dimensional display according to an example embodiment. FIG. 6C illustrates an embodiment of gradually increasing the sense of depth of the object 640 according to the direction that crosses the screen display area 235 of the three-dimensional display according to an example embodiment. FIG. 6D is a flowchart 650 illustrating a fingerprint authentication operation of the electronic device 101 according to an example embodiment.

Referring to FIGS. 6A, 6B, 6C, and 6D, the electronic device 101 according to an embodiment may display a fingerprint authentication induction object 610 on the three-dimensional display 230 in operation 651.

The electronic device 101 according to an embodiment may recognize a user's touch (for example, a finger touch) corresponding to the fingerprint authentication induction object 610 displayed on the three-dimensional display 230 in operation 652. The electronic device 101 according to an embodiment may acquire the recognized user's touch input.

As an embodiment, the fingerprint authentication induction object 610 may be an object 610 for inducing a user's touch input for unlocking the electronic device 101 or authenticating the user. For example, the fingerprint authentication induction object 610 may be displayed as an image of a fingerprint at a predetermined location of the three-dimensional display 230 to induce the user's touch input. As an embodiment, the fingerprint authentication induction object 610 displayed on the three-dimensional display 230 may be displayed in the screen display area 235 of the three-dimensional display 230 (0 depth).

The electronic device 101 according to an embodiment may not output a feedback corresponding to authentication success despite of the user input (for example, user's finger touch) for the fingerprint authentication induction object 610. For example, the feedback of authentication success corresponding to the fingerprint authentication induction object 610 may stop displaying the fingerprint authentication induction object and authenticate the user or release the lock.

The electronic device 101 according to an embodiment may move the fingerprint authentication induction object 610 to a positive direction (+ depth) layer along the direction that crosses the screen display area of the three-dimensional display 230 in operation 653 as indicated by reference numeral 620 in FIG. 6A. The electronic device 101 according to an embodiment may change a sense of depth of the fingerprint authentication induction object 610 according to the direction that crosses the screen display area 235 of the three-dimensional display 230 as indicated by reference numeral 620.

Before outputting feedback corresponding to the fingerprint authentication induction object 610 according to fingerprint authentication success, the electronic device 101 according to an embodiment may change the sense of depth of the fingerprint authentication induction object 610 according to the direction that crosses the screen display area 235 of the three-dimensional display 230 as indicated by reference numeral 620. As an embodiment, before identifying fingerprint authentication success or fingerprint authentication failure, the electronic device 101 may change the sense of depth of the fingerprint authentication induction object 610 according to the direction that crosses the screen display area 235 of the three-dimensional display 230 as indicated by reference numeral 620.

As an embodiment, the electronic device 101 may move the fingerprint authentication induction object 610 in a positive direction (+ depth) along the direction that crosses the screen display area 235 of the three-dimensional display 230 as indicated by reference numeral 620. As an embodiment, the electronic device 101 may move the fingerprint authentication induction object 610 in a plane direction (for example, XY plane) in which the three-dimensional display 230 extends as indicated by reference numeral 620 so as not to overlap the fingerprint authentication induction object 610 displayed in the positive direction (+ depth) along the direction that crosses the screen display area 235 of the three-dimensional display 230 with a user's finger touch.

As an embodiment, the electronic device 101 may display information (progress status) related to the status of fingerprint authentication on the fingerprint authentication induction object 610 displayed in the positive direction (+ depth) along the direction that crosses the screen display area 235 of the three-dimensional display 230. For example, the electronic device 101 may separately display an area in which the finger touch is input and an area in which no finger touch is input on the fingerprint authentication induction object 610, thereby inducing the user to recognize the area in which no finger touch is input to properly input the finger touch.

The electronic device 101 according to an embodiment may not output feedback of authentication success corresponding to the fingerprint authentication induction object 610 as fingerprint authentication has failed, and move the fingerprint authentication induction object 610 to the positive direction (+ depth) layer along the direction that crosses the screen display area 235 of the three-dimensional display 230 as feedback of authentication failure as indicated by reference numeral 620.

As an embodiment, the electronic device 101 may detect release of the user input (for example, finger touch). As an embodiment, according to release of the user input, the electronic device 101 may return the fingerprint authentication induction object 610 to the screen display area 235 (0 depth) of the three-dimensional display 230.

The electronic device 101 according to an embodiment may identify whether fingerprint authentication is successful in operation 655.

When it is identified that the fingerprint authentication has been succeed (operation 655-Yes), the electronic device 101 according to an embodiment may move the fingerprint authentication induction object 610 to the (0 depth) layer on the three-dimensional display 230 in operation 656. As an embodiment, when it is identified that the fingerprint authentication has been succeed, the electronic device 101 may stop displaying the fingerprint authentication induction object 610.

When it is identified that the fingerprint authentication has failed (operation 655-No), the electronic device 101 according to an embodiment may move the fingerprint authentication induction object 610 to the negative direction (− depth) layer along the direction that crosses the screen display area 235 of the three-dimensional display 230 in operation 658 as indicated by reference numeral 630 in FIG. 6B. The electronic device 101 according to an embodiment may change a sense of depth of the fingerprint authentication induction object 610 according to the direction that crosses the screen display area 235 of the three-dimensional display 230 as indicated by reference numeral 630.

Based on failure of the fingerprint authentication, the electronic device 101 according to an embodiment may change the sense of depth of the fingerprint authentication induction object 610 according to the direction that crosses the screen display area 235 of the three-dimensional display 230 as indicated by reference numeral 630 as feedback of the authentication failure corresponding to the fingerprint authentication induction object 610.

As an embodiment, the electronic device 101 may display information related to failure of the fingerprint authentication on the fingerprint authentication induction object 610 displayed in the negative direction (− depth) along the direction that crosses the screen display area 235 of the three-dimensional display 230. As an embodiment, the electronic device 101 may display a guide corresponding to a touch input for user's fingerprint authentication.

The electronic device 101 according to an embodiment may apply a predetermined graphic effect to the fingerprint authentication induction object 610 in operation 659. For example, the predetermined graphic effect may be a black and white effect for the fingerprint authentication induction object. For example, the predetermined graphic effect may be a bounce effect for the fingerprint authentication induction object 610. For example, the predetermined graphic effect may be a blur effect for the fingerprint authentication induction object 610. For example, the predetermined graphic effect may be a fade-out effect for the fingerprint authentication induction object 610. For example, the predetermined graphic effect may be a wiggle effect for the fingerprint authentication induction object 610.

As an embodiment, the electronic device 101 may detect release of the user input (for example, finger touch). As an embodiment, according to release of the user input, the electronic device 101 may return the fingerprint authentication induction object 610 to the screen display area 235 (0 depth) of the three-dimensional display 230.

As an embodiment, as failure of the fingerprint authentication is repeated, the electronic device 101 may gradually move the fingerprint authentication object 610 to the negative direction (− depth) layer along the direction that crosses the screen display area 235 of the three-dimensional display 230. For example, when the number of failure of the fingerprint authentication is a predetermined number or more, the electronic device 101 may enter an account lock state and, as the number of failure of the fingerprint authentication approaches an account lock condition, may gradually move the fingerprint authentication induction object 610 to the negative direction along the direction that crosses the screen display area 235 of the three-dimensional display 230.

As illustrated in FIG. 6C, the electronic device 101 according to an embodiment may display a PIN code object 640 on the three-dimensional display 230, based on failure of the fingerprint authentication. As an embodiment, according to failure of the PIN code authentication, the electronic device 101 may move the PIN code object 640 to the negative direction (− depth) layer along the direction that crosses the screen display area 235 of the three-dimensional display 230.

For example, when the number of failure of the PIN code authentication is a predetermined number or more, the electronic device 101 may enter an account lock state and, as the number of failure of the PIN code authentication approaches an account lock condition, may gradually move the PIN code object 640 to the negative direction along the direction that crosses the screen display area 235 of the three-dimensional display 230.

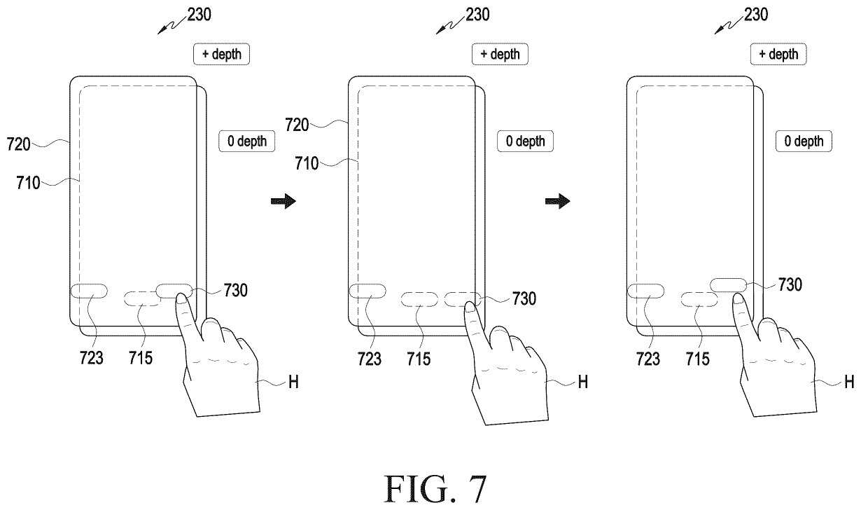

FIG. 7 illustrates an embodiment of a user input for an inactive object 730 according to an example embodiment.

Referring to FIG. 7, the electronic device 101 according to an embodiment may acquire a user input for an object 715, 723, or 730 included in a stereoscopic screen displayed on the three-dimensional display 230. For example, the object 715, 723, or 730 may be located on a (0 depth) layer 710 of the three-dimensional display 230 or a positive direction (+ depth) layer 720 along the direction that crosses the screen display area 235 of the three-dimensional display 230. For example, the object 715, 723, or 730 may be a button for receiving a touch input by a user's hand (H).

The electronic device 101 according to an embodiment may execute an application or a task corresponding to a user input for the object 715, 723, or 730. For example, in the case of the active object 715 or 723, the electronic device 101 may output predetermined feedback in response to the user input for the object 715 or 723.

The object 730 according to an embodiment may be in an inactive state in which predetermined feedback cannot be output in response to the user input.

When receiving the user input for the inactive object 730, the electronic device 101 according to an embodiment may not output predetermined feedback in response to the user input for the object 730. However, when there is no response to the user input, the user may determine that the system error or processing speed does not reach the expected speed, and thus fatigue due to the system use may occur.

The electronic device 101 according to an embodiment may identify that the input for the object 730 is in the inactive state, based on attributes of the object 730. The electronic device 101 according to an embodiment may move the object 730 located on the positive direction (+ depth) layer 720 along the direction that crosses the screen display 235 of the three-dimensional display 230 in the negative direction along the direction that crosses the screen display area 235 of the three-dimensional display 230 in response to the user input. For example, the electronic device 101 may move the object 730 to the (0 depth) layer 720 in the screen display area 235 of the three-dimensional display 230.

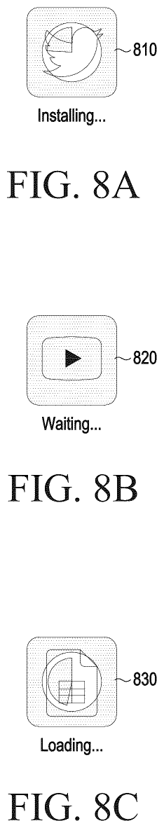

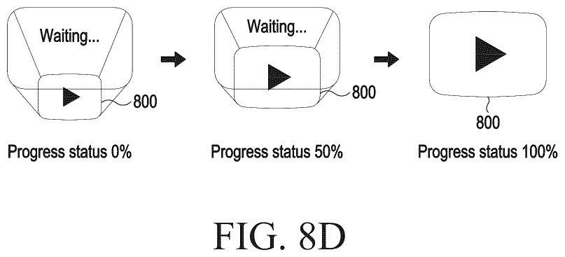

FIGS. 8A, 8B, and 8C illustrate inactive objects 810, 820, and 830 according to various embodiments of the disclosure. FIG. 8D illustrates an embodiment of changing a sense of depth of the object 800 according to the direction that crosses the screen display area 235 of the three-dimensional display 230 according to an example embodiment.

Referring to FIGS. 8A, 8B, 8C, and 8D, the electronic device 101 according to an embodiment may change the sense of depth of objects 800, 810, 820, and 830 according to the direction that crosses the screen display area 235 of the three-dimensional display 230 in response to user inputs for the inactive objects 800, 810, 820, and 830. The objects 800, 810, 820, and 830 according to an embodiment may be in an inactive state in which predetermined feedback cannot be output in response to the user inputs.

As an embodiment, the inactive object 810 for the user input may be a user interface (UI) corresponding to content which is being downloaded or installed as illustrated in FIG. 8A.

As an embodiment, the inactive object 820 for the user input may be a UI corresponding to content which is being searched for or waited as illustrated in FIG. 8B.

As an embodiment, the inactive object 830 for the user input may be a UI corresponding to an image, a video, or text which is being loaded as illustrated in FIG. 8C.

In response to the user input, the electronic device 101 according to an embodiment may temporarily move the object 800, 810, 820, or 830 to the positive direction (+ depth) layer along the direction that crosses the screen display area 235 of the three-dimensional display 230 or move the negative direction (− depth) layer along the direction that crosses the screen display area 235 of the three-dimensional display 230, so as to provide visual feedback in response to the user input for the object 800, 810, 820, or 830.

The electronic device 101 according to an embodiment may change the sense of depth of the object 800, 810, 820, or 830 according to the direction that crosses the screen display area 235 of the three-dimensional display 230, based on attributes of the object 800, 810, 820, or 830 in response to the user input as illustrated in FIG. 8D.

As an embodiment, the electronic device 101 may change the sense of depth according to the direction that crosses the screen display area 235 of the three-dimensional display 230 in accordance with a progress status of a function corresponding to the user input for the object 800, 810, 820, or 830. For example, the electronic device 101 may gradually change the sense of depth of the object according to the direction that crosses the screen display area 235 of the three-dimensional display 230 depending on the progress of the function so as to allow the user to recognize the progress status of the function corresponding to the object 800, 810, 820, or 830. For example, according to the progress status of the function corresponding to the object 800, 810, 820, or 830, the electronic device 101 may move the object 800, 810, 820, or 830 to the target depth by gradually moving the object 800, 810, 820, or 830 to the negative direction (− depth) layer along the direction that crosses the screen display area 235 of the three-dimensional display 230. Accordingly, it is possible to reduce the fatigue of using the system by improving the predictability of the user.

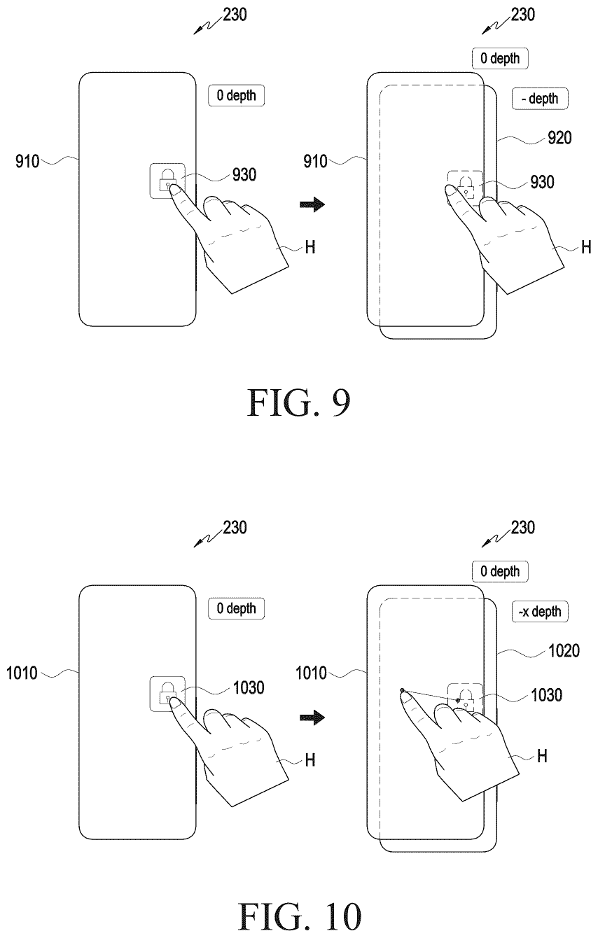

FIG. 9 illustrates a user input for an unselectable object 930 according to an example embodiment.

Referring to FIG. 9, the electronic device 101 according to an embodiment may receive a user input for the object 930 and identify that the object cannot be selected based on attributes of the object 930. As an embodiment, the electronic device 101 may move the object 930 in a predetermined direction along the direction that crosses the screen display area 235 of the three-dimensional display 230 in response to the user input for the unselectable object 930.

For example, the user input may be a touch & hold input or a long press input for the object 930 by a user's hand (H).

For example, the unselectable object 930 may be the object 930 having no additional function corresponding to the long press input. For example, the unselectable object 930 may be a UI which cannot be edited, moved ore removed in the system of the electronic device 101. For example, the unselectable object 930 may be UI corresponding to a clock, a date, a battery, and/or a signal sensitivity included in an always on display (AOD) screen. For example, the unselectable object 930 may be a UI corresponding to a security file, photo, and/or application preset by the user.

As an embodiment, the electronic device 101 may change the sense of depth of the object 930 according to the direction that crosses the screen display area 235 of the three-dimensional display 230 in response to the user input for the unselectable object 930. For example, the electronic device 101 may separate the object 930 from a user touch input by moving the object 930 located on a (0 depth) layer 910 of the three-dimensional display 230 to a negative direction (− depth) direction layer 920 along the direction that crosses the screen display area 235 of the three-dimensional display 230. For example, it is also possible to move the object 930 to the positive direction (+ depth) layer along the direction that crosses the screen display area 235 of the three-dimensional display 230.

FIG. 10 illustrates a user input for an immovable object 1030 according to an example embodiment.

Referring to FIG. 10, the electronic device 101 according to an embodiment may receive a user input for the object 1030 and identify that the object cannot be moved based on attributes of the object 1030. As an embodiment, the electronic device 101 may move the object 1030 in a predetermined direction along the direction that crosses the screen display area 235 of the three-dimensional display 230 in response to the user input for the immovable object 1030.

For example, the user input may be a touch & drag input for the object 1030 by a user's hand (H).

For example, the immovable object 1030 may be a UI corresponding to a lock file. For example, the immovable object 1030 may be a floating button of which the location is fixed. For example, the immovable object 1030 may be a fixed picture in picture (PIP).

As an embodiment, the electronic device 101 may change the sense of depth of the object 1030 according to the direction that crosses the screen display area 235 of the three-dimensional display 230 in response to the user input for the immovable object 1030. For example, the electronic device 101 may separate the object 1030 from a user touch input by moving the object 1030 located on the (0 depth) layer 1010 of the three-dimensional display 230 to the negative direction (−x depth) direction layer 1030 along the direction that crosses the screen display area 235 of the three-dimensional display 230. For example, it is also possible to move the object 1030 to the positive direction (+ depth) layer along the direction that crosses the screen display area 235 of the three-dimensional display 230.

As an embodiment, the electronic device 101 may move the object 1030 by a movement distance (−x depth) proportional to a movement amount (x) of the user input along a the direction that crosses the screen display area 235 of the three-dimensional display 230 in response to the user input for the immovable object 1030. For example, the electronic device 101 may move the object 1030 by the movement distance corresponding to the movement amount (x) of the user input for the immovable object 1030 in the negative direction (− depth) along the direction that crosses the screen display area 235 of the three-dimensional display 230. For example, as the movement amount (x) of the user input increases, the movement distance to the negative direction layer (−x depth) 1030 along the direction that crosses the screen display area 235 of the three-dimensional display 230 may increase.

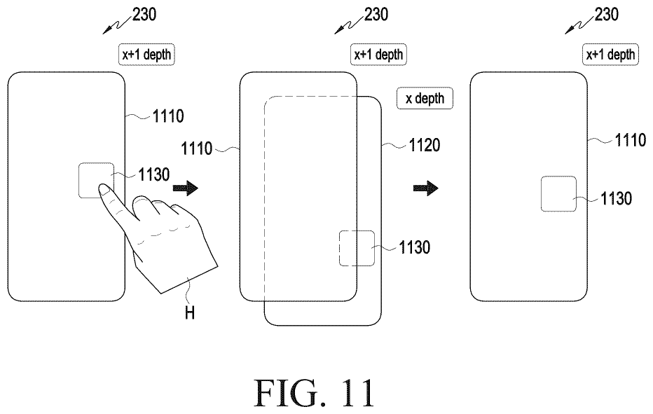

FIG. 11 illustrates a user input for an immovable or uncopiable object 1130 according to an example embodiment.

Referring to FIG. 11, the electronic device 101 according to an embodiment may display each of a plurality of layers 1110 and 1120 located at different depth in the direction that crosses the screen display area 235 of the three-dimensional display 230. As an embodiment, the electronic device 101 may display a folder page, a home screen page, and/or an application page at different depth in the direction that crosses the screen display area 235 of the three-dimensional display 230, and each page may include an icon and/or a widget.

As an embodiment, a user input for moving or copying the object 1130 at different depth may be a pinch input by a user's hand (H). As an embodiment, the user input for moving or copying the object 1130 at different depth may be an input for a key that controls volume.

As an embodiment, the electronic device 101 may display the object 1130 located in the folder page, the home screen page, and/or the application page displayed at different depth. The electronic device 101 according to an embodiment may receive the user input for the object 1130 and identify that the object 1130 cannot be moved or copied according to the user input, based on attributes of the object 1130.

As an embodiment, the electronic device 101 may move the object 1130 to the previous location before movement in the direction that crosses the screen display area 235 of the three-dimensional display 230, based on the user input in response to the user input for the immovable or uncopiable object 1130.

For example, the electronic device 101 may receive a user input of moving or copying the object 1130 located on a X+1 depth layer 1110 to a X depth layer 1120 and identify that the object 1130 cannot be moved or copied based on attributes of the object 1130. For example, the electronic device 101 may move the object 1130 to the X depth layer 1120 according to the user input and move the object 1130 to bounce back to the X+1 depth layer 1110, based on identification that the object 1130 cannot be moved or copied.

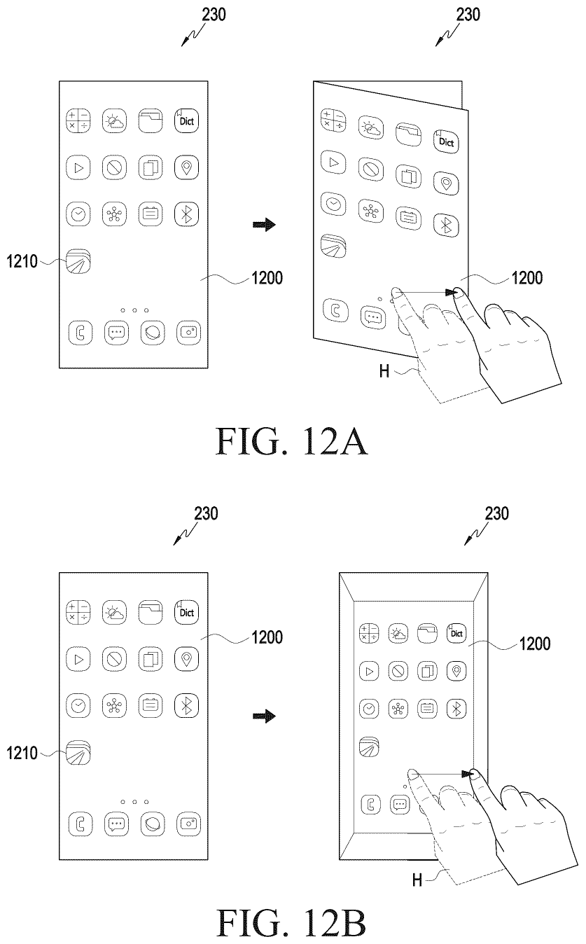

FIGS. 12A and 12B illustrate a user input for a home screen 1200 having a plurality of pages according to an example embodiment.

Referring to FIGS. 12A and 12B, the electronic device 101 according to an embodiment may include a plurality of slidable pages in the home screen 1200. For example, the electronic device 101 may slide the plurality of pages arranged in left and right directions according to a swipe input to the left and right directions by a user's hand (H). For example, a plurality of pages may be included in a folder screen or an application screen in addition to the home screen 1200, and the scenario described below may be applied thereto.

The electronic device 101 according to an embodiment may acquire the swipe input by the user's hand (H) for the plurality of slidable pages in the home screen 1200. As an embodiment, in response to the swipe input for the page, the electronic device 101 may slide the page to an adjacent page in a direction corresponding to the swipe input.

As an embodiment, when there is no page slidable to the direction corresponding to the user input for the page, the electronic device 101 may identify that the page cannot be moved any more. As an embodiment, the electronic device 101 may move at least a portion of the home screen 1200 in the direction that crosses the screen display area 235 of the three-dimensional display 230 in response to the user input.

As an embodiment, when there is no page slidable to the right side in response to the user input to the right side, the electronic device 101 may identify that the page cannot be moved any more as illustrated in FIGS. 12A and 12B.

As an embodiment, the electronic device 101 may sequentially move the home screen 1200 corresponding to the user input in the direction that crosses the screen display area 235 of the three-dimensional display 230, so as to tilt the pages of the home screen as illustrated in FIG. 12A.

As an embodiment, the electronic device 101 may move all of the home screen 1200 corresponding to the user input in the depth direction (for example, − depth direction) along the direction that crosses the screen display area 235 of the three-dimensional display 230 as illustrated in FIG. 12B.

As an embodiment, in each page included in the home screen 1200, icons or widgets may be arranged, and an object 1210 may be an icon or a widget arranged in each page.

The electronic device 101 according to an embodiment may receive a user input of moving the object 1210 arranged in the page of the home screen 1200 to an adjacent page. For example, when receiving a touch & drag input to a specific direction for the object 1210, the electronic device 101 may move the object 1210 to the adjacent page in the specific direction as feedback corresponding to the user input.

When there is no page slidable to the direction corresponding to the user input for the object 1210, the electronic device 101 according to an embodiment may identify that the object 1210 cannot be moved in the corresponding direction any more. As an embodiment, the electronic device 101 may move at least a portion of the page of the home screen 1200 displayed in the background of the object 1210 in the direction that crosses the screen display area 235 of the three-dimensional display 230 in response to the user input.

As an embodiment, when there is no page slidable to the right side in response to the user input to the right side, the electronic device 101 may identify that the object 1210 cannot be moved any more as illustrated in FIGS. 12A and 12B.

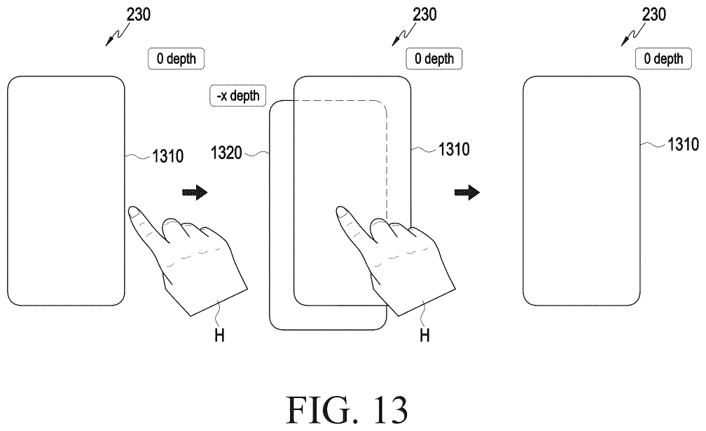

FIG. 13 illustrates a user input for a background screen 1310 according to an example embodiment.

Referring to FIG. 13, the electronic device 101 according to an embodiment may receive a user input for the screen 1310 displayed in the background. For example, the user input may be an input of pushing and moving the screen 1310 or an input of dragging.

When receiving the user input for the screen 1310 displayed in the background, the electronic device 101 according to an embodiment may move the screen 1310 in the direction corresponding to the user input. For example, the screen 1310 displayed in the background may be a scrollable or slidable screen or may include a plurality of pages displayed at different depth.

As an embodiment, when the screen 1310 displayed in the background cannot be moved in the direction corresponding to the user input or in the case of movement from the top depth layer to the front or movement from the lowest depth layer to the back, the electronic device 101 may not output feedback corresponding to the user input.

As an embodiment, the electronic device 101 may move the screen 1310 displayed in the background in the direction that crosses the screen display area 235 of the three-dimensional display 230 in response to the user input. For example, the electronic device 101 may move all of the screen 1310 in the background to the negative direction layer (for example, −x depth direction) 1320 along the direction that crosses the screen display area 235 of the three-dimensional display 230.

As an embodiment, when the user input is released, the electronic device 101 may return the screen 1310 displayed in the background to the previous location according to the direction that crosses the screen display area 235 of the three-dimensional display 230.

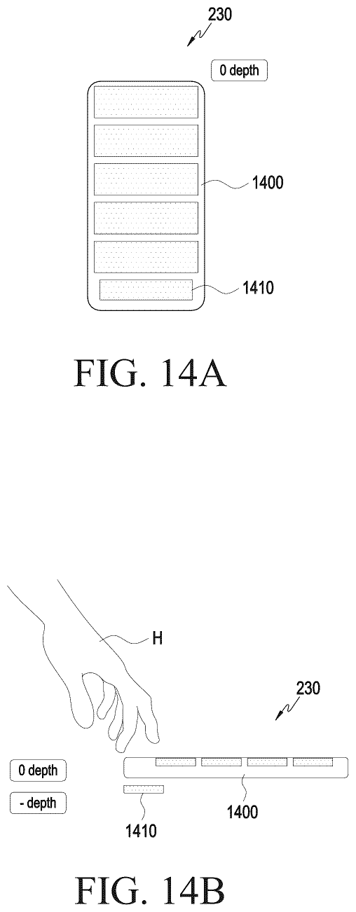

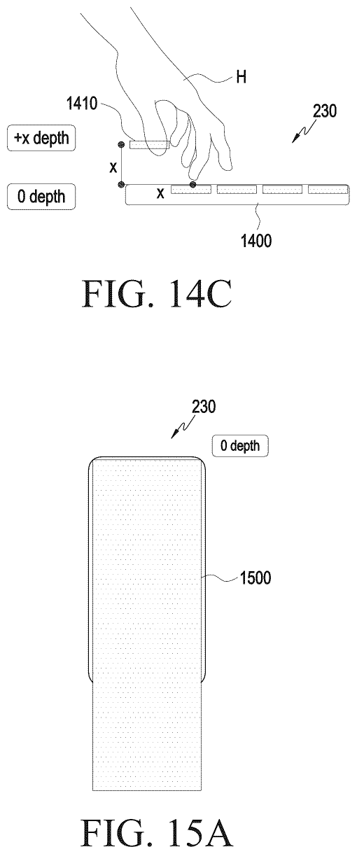

FIGS. 14A and 14B illustrate a scrollable list 1400 according to an example embodiment. FIG. 14C illustrates an embodiment of a user input for a scrollable list according to an example embodiment.

The electronic device 101 according to an embodiment may display the distinguishable list 1400 of contents such as menus, photos, images, paintings, or products on the three-dimensional display 230 as illustrated in FIG. 14A. As an embodiment, the electronic device 101 may scroll the list 1400 in a direction of a movement input in response to the user movement input for the list 1400.

The electronic device 101 according to an embodiment may move the content 1410 located at the bottom of the list 1400 in the direction that crosses the screen display area 235 of the three-dimensional display 230 as illustrated in FIG. 14B. For example, the electronic device 101 may display the content 1410 located at the bottom of the list 1400 of the distinguishable contents displayed on the three-dimensional display 230 on the negative direction layer (− depth) along the direction that crosses the screen display area 235 of the three-dimensional display 230.

The electronic device 101 according to an embodiment may move distinguishable content (not shown) located at the top of the list 1400 in the direction that crosses the screen display area 235 of the three-dimensional display 230. For example, the electronic device 101 may display the content (not shown) located at the top of the list 1400 of the distinguishable contents displayed on the three-dimensional display 230 on the positive direction layer (+ depth) along the direction that crosses the screen display area 235 of the three-dimensional display 230.

The electronic device 101 according to an embodiment may identify that the scroll is not possible any more in the state in which the content 1410 at the bottom or the content (not shown) at the top included in the list 1400 is displayed. As an embodiment, the electronic device 101 may move the content 1410 in the direction that crosses the screen display area 235 of the three-dimensional display 230, based on identification that the list 1400 cannot be scrolled.

As an embodiment, the electronic device 101 may move the content 1410 at the bottom or the content (not shown) at the top included in the list 1400 by the movement distance (x) proportional to the movement amount (x) of the user input in the direction that crosses the screen display area 235 of the three-dimensional display 230 as illustrated in FIG. 14C.

As an embodiment, when the user input is released, the electronic device 101 may return the content 1410 having moved in the direction that crosses the screen display area 235 of the three-dimensional display 230 to the previous location.

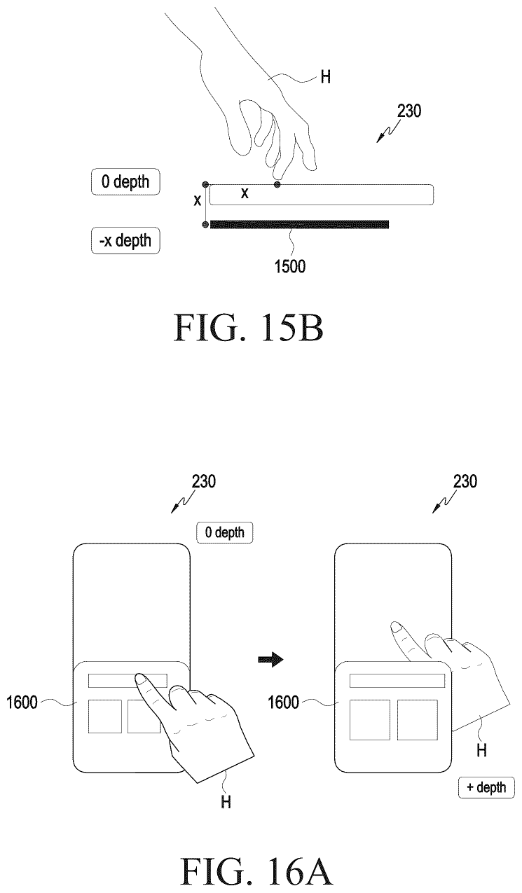

FIG. 15A illustrates scrollable content 1500 according to an example embodiment. FIG. 15B illustrates an embodiment of a user input for the scrollable content 1500 according to an example embodiment.

Referring to FIGS. 15A and 15B, the electronic device 101 according to an embodiment may display the scrollable content 1500 such as documents, paintings, photos, or images on the three-dimensional display 230. As an embodiment, the electronic device 101 may scroll the content 1500 in the direction of the movement input in response to the user movement input for the scrollable content 1500.

The electronic device 101 according to an embodiment may identify that the scroll is not possible in the state in which the bottom or the top of the content 1500 is displayed. As an embodiment, the electronic device 101 may move all of the content 1500 in the direction that crosses the screen display area 235 of the three-dimensional display 230, based on identification that the content 1500 cannot be scrolled.

As an embodiment, the electronic device 101 may move all of the content 1500 by the movement distance (x) proportional to the movement amount (x) of the user input in the direction that crosses the screen display area 235 of the three-dimensional display 230. As an embodiment, when the user input is released, the electronic device 101 may return the content 1500 having moved in the direction that crosses the screen display area 235 of the three-dimensional display 230 to the previous location.

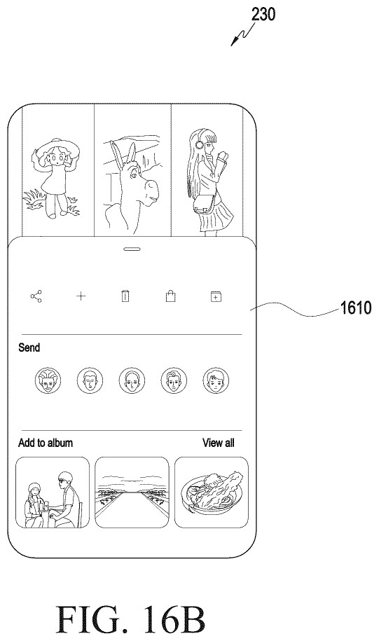

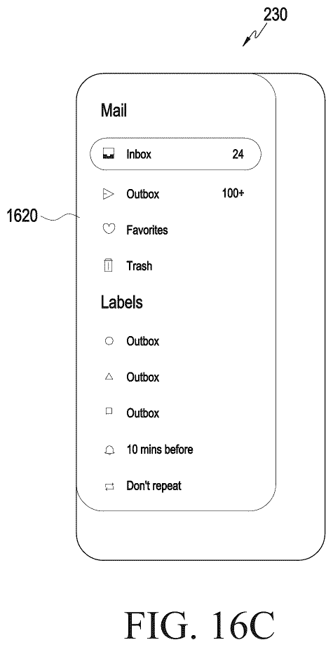

FIG. 16A illustrates a user input for a window 1600 of which movement or size change is limited according to an example embodiment. FIGS. 16B and 16C illustrate various examples of FIG. 16A.

Referring to FIGS. 16A, 16B, and 16C, the electronic device 101 according to an embodiment may display windows 1600 and 1610 of which movement is limited or windows 1600 and 1620 of which the size change is limited on the three-dimensional display 230.

As an embodiment, the electronic device 101 may display a bottom sheet 1610 arranged to be fixed to a portion of the screen display area 235 of the three-dimensional display 230 and configured to be changed to a predetermined size or smaller as illustrated in FIG. 16B.

As an embodiment, the electronic device 101 may display a navigation drawer 1620 which can be displayed in a predetermined size in a portion of the screen display area 235 of the three-dimensional display 230 as illustrated in FIG. 16C.

For the window 1600, 1610, or 1620 of which movement or size change is limited, the electronic device 101 according to an embodiment may receive a user input for movement or size change. As an embodiment, the electronic device 101 may move the window 1600, 1610, or 1620 or change the size in response to the user input within a limited range of the movement or size change.

The electronic device 101 according to an embodiment may identify that the window 1600, 1610, or 1620 cannot be moved or the size thereof cannot be changed in response to the user input outside the predetermined limited range. As an embodiment, the electronic device 101 may move the window 1600, 1610, or 1620 of which movement or size change is limited in the direction that crosses the screen display area 235 of the three-dimensional display 230.

As an embodiment, the electronic device 101 may move the window 1600, 1610, or 1620 by the movement distance proportional to the movement amount of the user input in the direction that crosses the screen display area 235 of the three-dimensional display 230 (for example, the positive direction (+ depth) along the direction that crosses the screen display area 235 of the three-dimensional display 230).

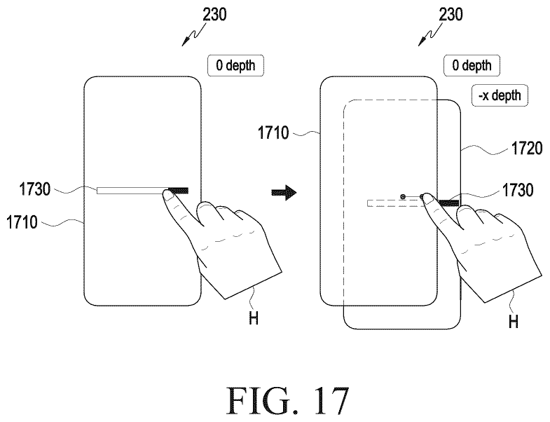

FIG. 17 illustrates a user input for a slider 1730 according to an example embodiment.

Referring to FIG. 17, the electronic device 101 according to an embodiment may display the slider 1730 for controlling the size of specific attributes on the three-dimensional display 230 according to sliding movement. For example, the slider 1730 may be a UI that controls screen brightness of the three-dimensional display 230 or controls volume of the speaker.

As an embodiment, the electronic device 101 may receive a touch input or a swipe input for a specific location of the user for the slider 1730. As an embodiment, the electronic device 101 may control the size of the specific attributes in response to the user input for the slider 1730.

As an embodiment, when receiving the user input outside the limited range for the slider 1730, the electronic device 101 may move the slider 1730 in the direction that crosses the screen display area 235 of the three-dimensional display 230. For example, the limited range for the slider 1730 may be changed by an environment of the electronic device 101. For example, restrictions may occur in controlling the volume for hearing protection, or restrictions may occur in controlling the screen brightness for battery protection.

As an embodiment, the electronic device 101 may move the slider 1730 located on a (0 depth) layer 1710 of the three-dimensional display 230 to a layer 1720 located in the negative direction (− depth) along the direction that crosses the screen display area 235 of the three-dimensional display 230 by the movement direction proportional to the movement amount of the user input.

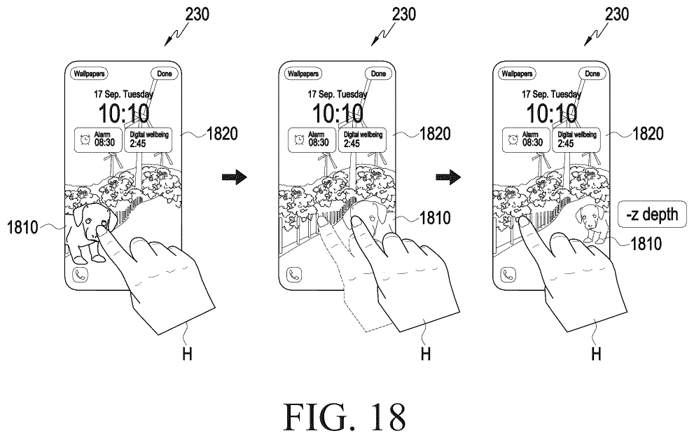

FIG. 18 illustrates a user movement input for an object 1810 according to an example embodiment.

Referring to FIG. 18, the electronic device 101 according to an embodiment may display a stereoscopic screen on the three-dimensional display 230, and the object 1810 may be included in the stereoscopic screen. As an embodiment, the object 1810 is three dimension including the direction that crosses the screen display area 235 of the three-dimensional display 230 and may be displayed on the three-dimensional display 230.

The electronic device 101 according to an embodiment may rotate or translate the object 1810 by the user input for the object 1810 displayed on the three-dimensional display 230. As an embodiment, the electronic device 101 may rotate or translate the object 1810 and display the same on the three-dimensional display 230 according to the user movement input.

When receiving the user movement input in the state in which the object 1810 displayed on the three-dimensional display 230 cannot be rotated or translated, the electronic device 101 according to an embodiment may move the object 1810 in the direction that crosses the screen display area 235 of the three-dimensional display 230.

As an embodiment, the electronic device 101 may move only the object 1810 in the direction that crosses the screen display area 235 of the three-dimensional display 230 while maintaining a background screen 1820 of the object 1810 on the three-dimensional display 230.

As an embodiment, the electronic device 101 may move the object 1810 in the direction that crosses the screen display area 235 of the three-dimensional display 230 (for example, the negative direction (− depth) along the direction that crosses the screen display area 235 of the three-dimensional display 230) by the movement distance proportional to the movement amount of the user input.

As an embodiment, when the user input is released, the electronic device 101 may return the object 1810 having moved in the direction that crosses the screen display area 235 of the three-dimensional display 230 to the previous location.

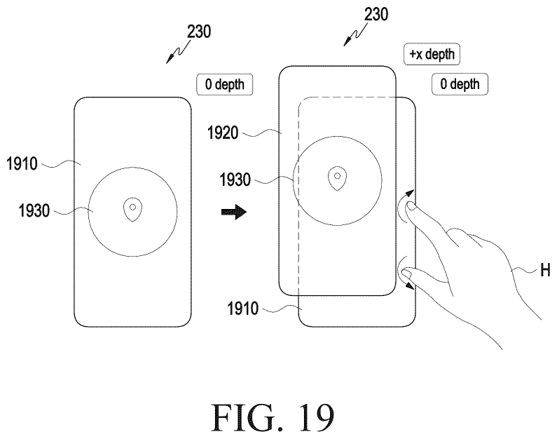

FIG. 19 illustrates a user size change input for an object 1930 according to an example embodiment.

Referring to FIG. 19, the electronic device 101 according to an embodiment may display a stereoscopic screen on the three-dimensional display 230, and the object 1930 may be included in the stereoscopic screen.

The electronic device 101 according to an embodiment may enlarge or reduce the object 1930 and display the same on the three-dimensional display 230 by the user input for the object 1930 displayed on the three-dimensional display 230.

When receiving a user enlargement input in the state in which the object 1930 displayed on the three-dimensional display 230 cannot be enlarged any more, the electronic device 101 according to an embodiment may move the object 1930 in the direction that crosses the screen display area 235 of the three-dimensional display 230. When receiving a user reduction input in the state in which the object 1930 displayed on the three-dimensional display 230 cannot be reduced any more, the electronic device 101 according to an embodiment may move the object 1930 in the direction that crosses the screen display area 235 of the three-dimensional display 230.

As an embodiment, the electronic device 101 may move the object 1930 located on a layer 1910 of the three-dimensional display 230 in the direction that crosses the screen display area 235 of the three-dimensional display 230 (for example, a positive direction (+x depth) layer 1920 along the direction that crosses the screen display area 235 of the three-dimensional display 230) by the movement distance proportional to the movement amount of the user input.

As an embodiment, when the user input is released, the electronic device 101 may return the object 1930 having moved in the direction that crosses the screen display area 235 of the three-dimensional display 230 to the previous location.

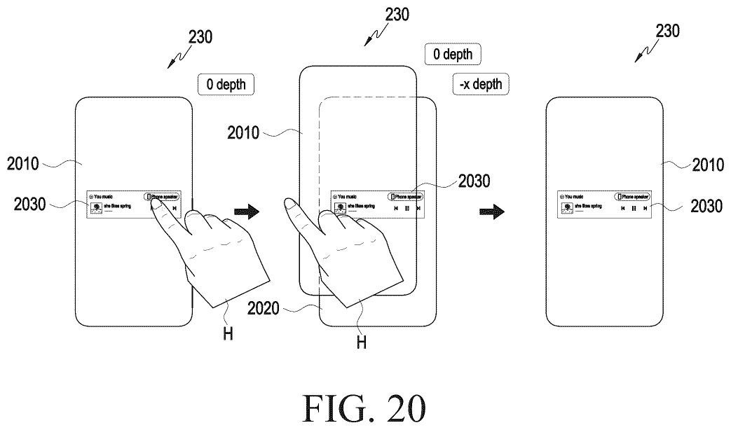

FIG. 20 illustrates a user end input for an object 2030 according to an example embodiment.

Referring to FIG. 20, the electronic device 101 according to an embodiment may display the object 2030 corresponding to a floating window, a floating icon, and/or a notification window on the three-dimensional display 230. For example, the electronic device 101 may display a floating window 2030 related to music being played, a notification window (not shown) related to information on arrival of Uber, a floating window (not shown) related to navigation directions, or a notification window (not shown) related to the current time of a timer on the three-dimensional display 230.

The electronic device 101 according to an embodiment may receive the user end input for the object 2030 corresponding to the floating window, the floating icon, and/or the notification window. As an embodiment, when receiving a user input of pushing (or throwing) the object 2030 on the three-dimensional display 230, the electronic device 101 may stop displaying the object 2030 and end an application corresponding to the object 2030.

When the electronic device 101 cannot stop displaying the object 2030 or cannot end the application corresponding thereto, the electronic device 101 according to an embodiment may move the object 2030 in the direction that crosses the screen display area 235 of the three-dimensional display 230.

As an embodiment, the electronic device 101 may move the object 2030 located on a (0 depth) layer 2010 of the three-dimensional display 230 in the direction that crosses the screen display area 235 of the three-dimensional display 230 (for example, a negative direction (−x depth) layer 2020 along the direction that crosses the screen display area 235 of the three-dimensional display 230).

As an embodiment, when the user input is released, the electronic device 101 may return the object 2030 having moved in the direction that crosses the screen display area 235 of the three-dimensional display 230 to the previous location.

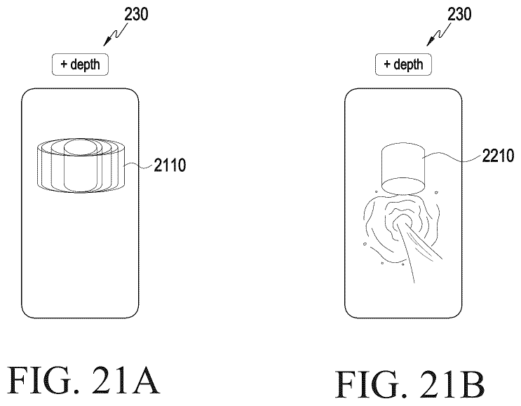

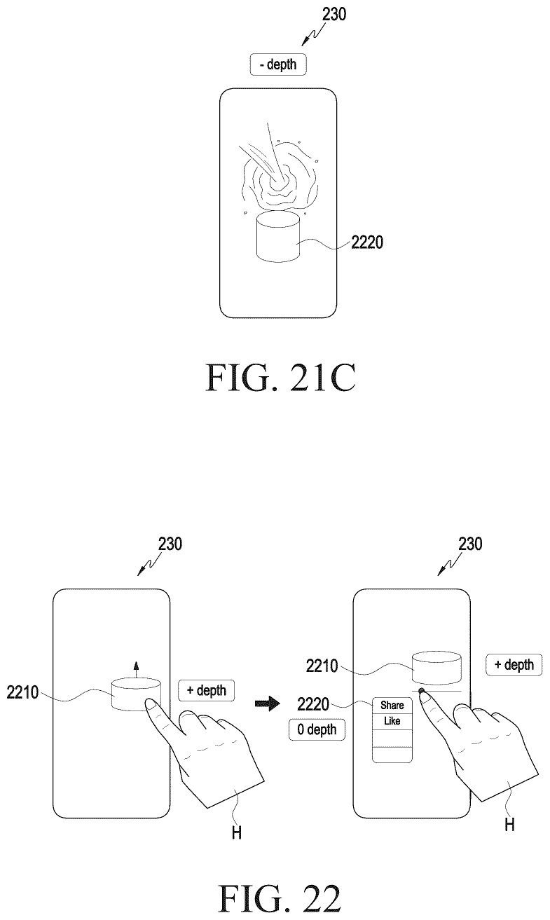

FIGS. 21A and 21B illustrate an embodiment of moving an object 2110 in a positive direction along the direction that crosses the screen display area 235 of the three-dimensional display 230 according to an example embodiment. FIG. 21C illustrates an embodiment of moving an object 2120 in a negative direction along the direction that crosses the screen display area 235 of the three-dimensional display 230 according to an example embodiment.

The electronic device 101 according to an embodiment may move the object 2110 or 2120 displayed on the three-dimensional display 230 in the direction that crosses the screen display area 235 of the three-dimensional display 230. As an embodiment, the electronic device 101 may move the object 2110 or 2120 in the positive direction (+ depth) along the direction that crosses the screen display area 235 of the three-dimensional display 230 or the negative direction (− depth) along the direction that crosses the screen display area 235 of the three-dimensional display 230.

When moving the object 2110 in the positive direction (+ depth) along the direction that crosses the screen display area 235 of the three-dimensional display 230, the electronic device 101 according to an embodiment may apply, to the object 2110, a predetermined effect corresponding to movement in the positive direction (+ depth) along the direction that crosses the screen display area 235 of the three-dimensional display 230.

As an embodiment, when moving the object 2110 in the positive direction (+depth) along the direction that crosses the screen display area 235 of the three-dimensional display 230 as illustrated in FIG. 21A, the electronic device 101 according to an embodiment may apply a shaking effect to the object 2110.

As an embodiment, as illustrated in FIG. 21B, when moving the object 2110 in the positive direction (+ depth) along the direction that crosses the screen display area 235 of the three-dimensional display 230, the electronic device 101 may apply, to the object 2110, an effect to rising water from the negative direction (− depth) along the direction that crosses the screen display area 235 of the three-dimensional display 230. When moving the object 2120 in the negative direction (− depth) along the direction that crosses the screen display area 235 of the three-dimensional display 230, the electronic device 101 according to an embodiment may apply, to the object 2120, a predetermined effect corresponding to movement in the negative direction (− depth) along the direction that crosses the screen display area 235 of the three-dimensional display 230. For example, as illustrated in FIG. 21C, the electronic device 101 may apply an effect of being submerged in the water to the object 2120 while moving the object 2120 in the negative direction (− depth) along the direction that crosses the screen display area 235 of the three-dimensional display 230.

The predetermined effects described as the examples are only examples, and the electronic device 101 may variously apply visual, auditory, and tactile effects according to movement of the object 2110 or 2120 in the direction that crosses the screen display area 235 of the three-dimensional display 230.

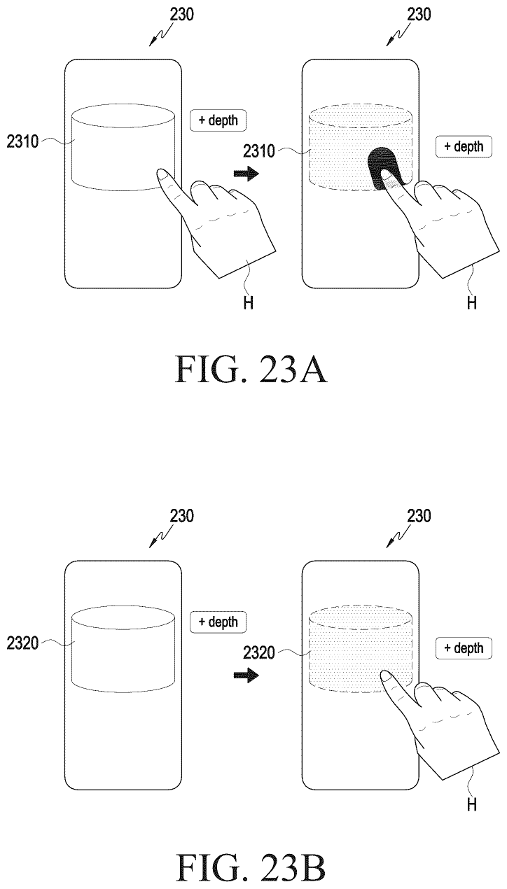

FIG. 22 illustrates an embodiment of moving an object 2210 located in the positive direction along the direction that crosses the screen display area 235 of the three-dimensional display 230 according to an example embodiment. FIGS. 23A and 23B illustrate an embodiment of applying a predetermined effect to an object 2310 or 2320 located in the positive direction along the direction that crosses the screen display area 235 of the three-dimensional display 230 according to an example embodiment.

Referring to FIGS. 22, 23A, and 23B, the electronic device 101 according to an embodiment may display the object 2210, 2310, or 2320 located in the positive direction along the direction that crosses the screen display area 235 of the three-dimensional display 230 on the three-dimensional display 230. As an embodiment, the electronic device 101 may move the object 2210, 2310, or 2320 in the positive direction along the direction that crosses the screen display area 235 of the three-dimensional display 230 as feedback corresponding to a user input for the object 2210, 2310, or 2320. As an embodiment, the electronic device 101 may display the object 2210, 2310, or 2320 included in a stereoscopic screen to be located in the positive direction along the direction that crosses the screen display area 235 of the three-dimensional display 230.

When receiving a user input corresponding to the object 2210, 2310, or 2320 located in the positive direction along the direction that crosses the screen display area 235 of the three-dimensional display 230, the electronic device 101 according to an embodiment may change attributes related to displaying of the object. As an embodiment, when the user input generated in the positive direction along the direction that crosses the screen display area 235 of the three-dimensional display 230 overlaps the object 2210, 2310, or 2320, the electronic device 101 may change attributes related to displaying of the object 2210, 2310, or 2320.

The electronic device 101 according to an embodiment may change the location of the object 2210 in a plane direction in which the three-dimensional display 230 extends as illustrated in FIG. 22. As an embodiment, the electronic device 101 may move the object 2210 in the plane direction (for example, coordinates in the XY plane) of the screen display area 235 of the three-dimensional display 230 to avoid overlapping with the user input.

As an embodiment, the electronic device 101 may identify whether a predetermined percentage (for example, most) of the object 2210 or more overlaps the user input, and when the predetermined percentage of the object 2210 or more overlaps the user input, change the location of the object 2210.

As an embodiment, the electronic device 101 may identify whether there is an extra space in the background screen in which the object 2210 is located, to which the object 2210 is to be moved, and when there is the extra space in the background screen to which the object 2210 is to be moved, change the location of the object 2210.

As an embodiment, the electronic device 101 may display an additional menu window 2220 on the three-dimensional display 230 by the user input for the object 2210. As an embodiment, the electronic device 101 may display the additional menu window 2220 on the three-dimensional display 230 (0 depth). As an embodiment, the electronic device 101 may display the additional menu window 2220 at the location adjacent to the location at which the user input is generated.

The electronic device 101 according to an embodiment may apply a predetermined effect to a part which overlaps the user input for the object 2310 as illustrated in FIG. 23A. For example, the predetermined effect may be a blur effect of blurring displaying of the object 2310 or a transparency effect of transparently displaying the object 2310.

As an embodiment, the electronic device 101 may identify whether a predetermined percentage of the object 2310 or less overlaps the user input, and when the predetermined percentage of the object 2310 or less overlaps the user input, apply a predetermined effect to the part which overlaps the user input of the object 2310.

As an embodiment, the electronic device 101 may identify whether there is an extra space in the background screen in which the object 2310 is located, to which the object 2310 is to be moved, and when there is no extra space in the background screen to which the object 2310 is to be moved, apply a predetermined effect to the part which overlaps the user input of the object 2310.

The electronic device 101 according to an embodiment may apply a predetermined effect to all of the object 2320 which overlap the user input as illustrated in FIG. 23B. For example, the predetermined effect may be a blur effect of blurring displaying of the object 2320 or a transparency effect of transparently displaying the object 2320.

As an embodiment, based on the user input being received, the electronic device 101 may display the object 2210, 2310, or 2320 to be continuously located in the positive direction (+ depth) along the direction that crosses the screen display area 235 of the three-dimensional display 230 while moving the object 2210 or applying a predetermined effect to the object 2310 or 2320. As an embodiment, the electronic device 101 may return the object 2210, 2310, or 2320 to the previous location or remove the predetermined effect, based on the user input being released.

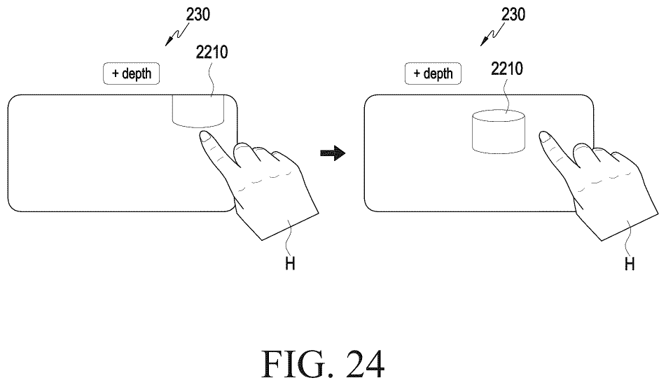

FIG. 24 illustrates an embodiment of moving the object 2210 located in the positive direction along the direction that crosses the screen display area 235 of the three-dimensional display 230 according to an example embodiment.

Referring to FIG. 24, when acquiring a user input corresponding to the object 2210 located in the positive direction along the direction that crosses the screen display area 235 of the three-dimensional display 230, the electronic device 101 according to an embodiment may move the object 2210 in a plane direction (XY plane) of the three-dimensional display 230.

As an embodiment, when receiving the user input, the electronic device 101 may display the object 2210 corresponding to a notification or a warning message for the user input in the positive direction along the direction that crosses the screen display area 235 of the three-dimensional display 230. As an embodiment, the electronic device 101 may move the object 2210 corresponding to the notification or warning message displayed in the positive direction along the direction that crosses the screen display area 235 of the three-dimensional display 230 in the plane direction (XY plane) of the three-dimensional display 230 to avoid overlapping with the user input.

As an embodiment, the electronic device 101 may configure a movement location of the object 2210, based on an input location of the user for the three-dimensional display 230 and/or the position of the electronic device 101.

For example, when the electronic device 101 is in the portrait mode extending in the vertical direction and there is a space in the size (for example, height (N)) of the object 2210 or larger in the upper part of the input location of the user, the object 2210 may be moved in an up direction (+Y) by the height (N). For example, when there is no space in the size (for example, height (N)) of the object 2210 or larger in the upper part of the input location of the user, the object 2210 may be moved in a down direction (−Y).

For example, as illustrated in FIG. 24, when the electronic device 101 is in a landscape mode extending in the horizontal direction and there is no space in the size (for example, height (N)) of the object 2210 or larger in the upper part of the input location of the user, the object 2210 may be moved in the horizontal direction (X).

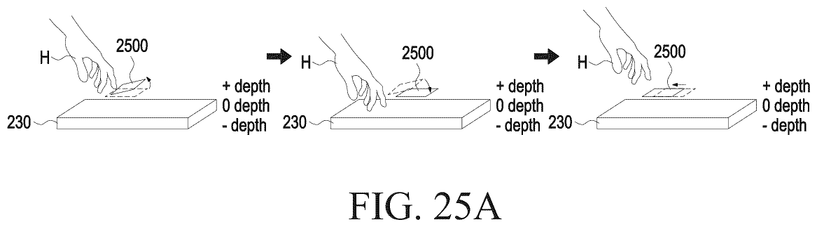

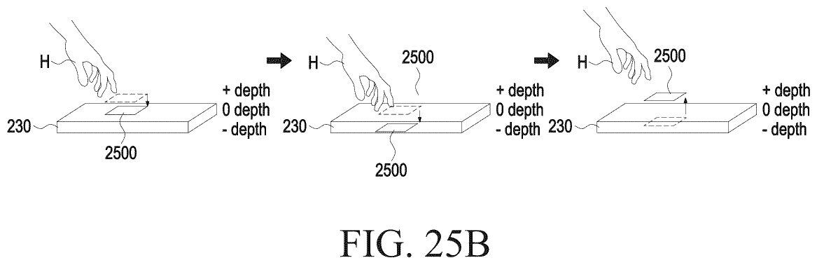

FIGS. 25A and 25B illustrate a visual effect applied to an object 2500 located in positive direction along a direction that crosses the screen display area 235 of the three-dimensional display 230 according to an example embodiment.

Referring to FIGS. 25A and 25B, the electronic device 101 according to an embodiment may display an object 2500 located in a positive direction (+depth) along the direction that crosses the screen display area 235 of the three-dimensional display 230 and receive a user input corresponding to the object 2500 in the positive direction along the direction that crosses the screen display area 235 of the three-dimensional display 230.

For example, the user input may be a touch input for the three-dimensional display 230 integrally formed with a touch panel (for example, the touch panel 260 of FIG. 2). For example, the user input may be a proximity input in proximity to the three-dimensional display 230, and the electronic device 101 may detect the proximity input by using the touch panel 260 or a camera sensor (for example, the camera sensor 270 of FIG. 2).

When receiving a user input that overlaps the object 2500 in the state where the object 2500 is located in a positive direction (+ depth) along the direction that crosses the screen display area 235 of the three-dimensional display 230, the electronic device 101 according to an embodiment may apply a visual effect to the object 2500.

As illustrated in FIG. 25A, as an embodiment, the electronic device 101 may apply a bounce effect corresponding to tilting in response to the user input to the object 2500. As an embodiment, the electronic device 101 may move the object 2500 such that the object 2500 does not overlap the user input. As an embodiment, the electronic device 101 may return the object to the previous location or remove a predetermined effect, based on release of the user input.

For example, the electronic device 101 may apply a slipping effect corresponding to slipping of the object 2500 in response to the user input. For example, the electronic device 101 may change attributes (for example, blur effect, transparency effect, or graying effect) related to displaying of the object 2500 in response to the user input.

As illustrated in FIG. 25B, as an embodiment, the electronic device 101 may move the object 2500 in the direction that crosses the screen display area 235 of the three-dimensional display 230 in response to the user input. For example, when receiving the user input, the electronic device 101 may move the object 2500 located in the positive direction (+ depth) along the direction that crosses the screen display area 235 of the three-dimensional display 230 to the three-dimensional display 230 (0 depth) or move the same in the negative direction (− depth) along the direction that crosses the screen display area 235 of the three-dimensional display 230. For example, the electronic device 101 may change attributes (for example, blur effect, transparency effect, or graying effect) related to displaying of the object 2500 simultaneously with moving the object 2500.

As an embodiment, the electronic device 101 may return the object 2500 to the previous location or remove a predetermined effect, based on release of the user input.

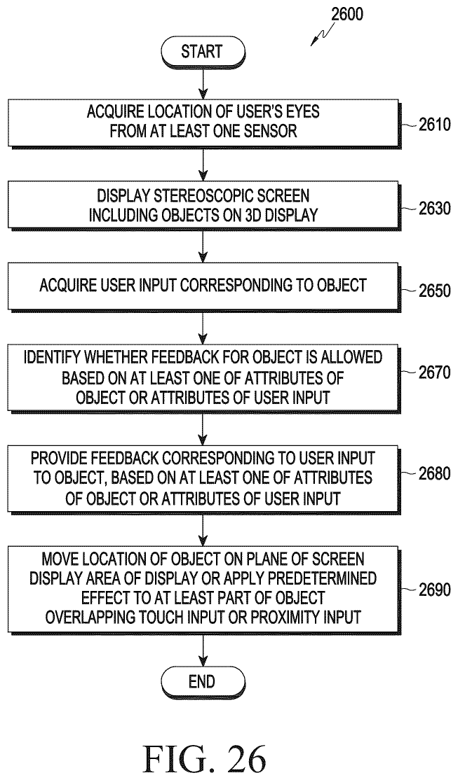

FIG. 26 is a flowchart 2600 illustrating a method of operating the electronic device 101 according to an example embodiment.

Referring to FIG. 26, the electronic device 101 according to an embodiment may acquire the location of user's eyes from at least one sensor 240 or 176 in operation 2610. As an embodiment, the electronic device 101 may receive values related to the location of the user, the location of the user's face, and/or the location of the user's eyes from the eye tracking sensor 240.

The electronic device 101 according to an embodiment may display a stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on the three-dimensional display 230 or 160 in operation 2630. As an embodiment, the electronic device 101 may display the screen on the three-dimensional display 230 or 160 to allow the stereoscopic screen to be recognized by the user's eyes, based on the location of the user's eyes received from at least one sensor 240 or 176.

The electronic device 101 according to an embodiment may acquire a user input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in operation 2650. For example, the user input may be a touch input through a touch panel, and the touch input may include a proximity input according to proximity of the user's finger to the touch panel.

The electronic device 101 according to an embodiment may identify whether feedback corresponding to a user input for the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is allowed based on at least one of attributes of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 or attributes of the user input in operation 2670.

As an embodiment, the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be a screen displayed on the three-dimensional display 230 or 160 or various objects included in the screen.

The electronic device 101 according to an embodiment may provide feedback corresponding to the user input for the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, based on the attributes of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, and/or the attributes of the user input in operation 2680.

The electronic device 101 according to an embodiment may change the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 according to the direction that crosses the screen display area 235 of the three-dimensional display 230 or 160 in operation 2680.

For example, the electronic device 101 may move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in the positive direction (+ depth) along the direction that crosses the screen display area 235 of the three-dimensional display 230 or 160 or the negative direction (− depth) along the direction that crosses the screen display area 235 of the three-dimensional display 230 or 160.

The electronic device 101 according to an embodiment may change attributes related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in operation 2690.

As an embodiment, the electronic device 101 may move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in the positive direction (+ depth) along the direction that crosses the screen display area 235 of the three-dimensional display 230 or 160 and, when the user input for the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is generated in the positive direction along the direction that crosses the screen display area 235 of the three-dimensional display 230 or 160, the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 and the user input may overlap. As an embodiment, the electronic device 101 may change attributes related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 that overlaps the user input.

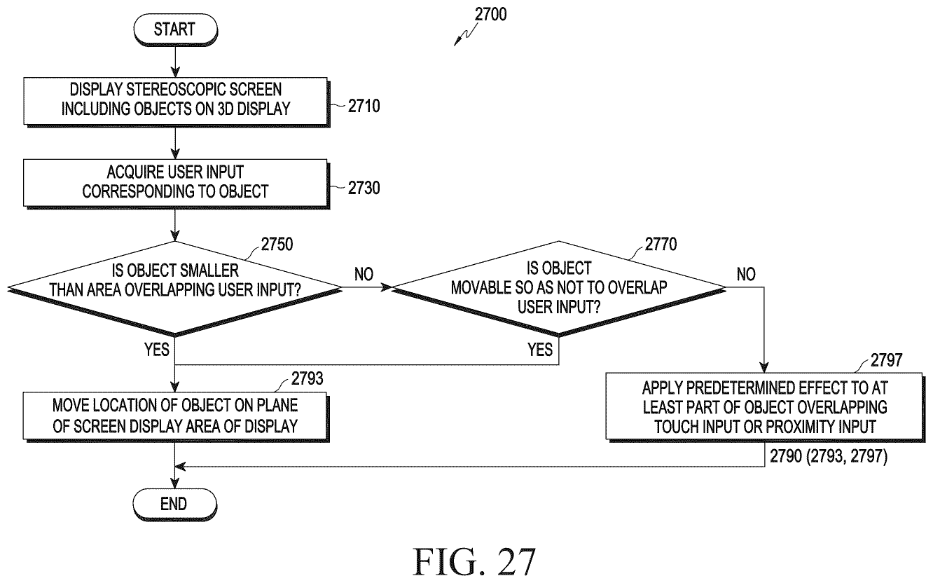

FIG. 27 is a flowchart 2700 illustrating a method of operating the electronic device 101 according to an example embodiment.

Referring to FIG. 27, the electronic device 101 according to an embodiment may display a stereoscopic screen including the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on the three-dimensional display 230 or 160 in operation 2710. As an embodiment, the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be located in the positive direction (+ depth) along the direction that crosses the screen display area 235 of the three-dimensional display 230 or 160.

As an embodiment, the electronic device 101 may display the stereoscopic screen on the three-dimensional display 230 or 160, based on the location of the user's eyes acquired from at least one sensor 240 or 176 as illustrated in FIG. 26.

The electronic device 101 according to an embodiment may acquire a user input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in operation 2730.

The electronic device 101 according to an embodiment may identify whether the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is smaller than an area that overlaps the user input in operation 2750.

When it is identified that the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is not smaller than the area that overlaps the user input (operation 2750-No), the electronic device 101 according to an embodiment may identify whether the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is movable so as not to overlap the user input in operation 2770.

The electronic device 101 according to an embodiment may change attributes related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 that overlaps the user input, based on whether the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is smaller than the area that overlaps the user input (operation 2750) or whether the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is movable so as not to overlap the user input (operation 2770).

When it is identified that the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is smaller than the area that overlaps the user input (operation 2750-Yes) or when the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is movable so as not to overlap the user input (operation 2770-Yes), the electronic device 101 according to an embodiment may change the location of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a plane direction in which the three-dimensional display 230 or 160 extends in operation 2793.

When the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is not movable so as not to overlap the user input (operation 2770-No), the electronic device 101 according to an embodiment may apply a predetermined effect to at least some of the objects 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 that overlap the user input in operation 2797.

The technical subjects pursued in the disclosure are not limited to the above mentioned technical subjects, and other technical subjects which are not mentioned may be clearly understood through the following descriptions by those skilled in the art of the disclosure.

The effects that can be realized by the disclosure are not limited to the above-described effects, and other effects that have not been mentioned may be clearly understood by those skilled in the art from the following description.

The electronic device 101 according to an example embodiment may include the memory 130 storing instructions, the three-dimensional (3D) display 230 or 160 capable of displaying a stereoscopic screen, and at least one processor 210 or 120. The instructions may cause, when executed by the at least one processor 210 or 120, the electronic device 101 to display the stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on the 3D display 230 or 160. The instructions may cause, when executed by the at least one processor 210 or 120, the electronic device 101 to obtain a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The instructions may cause, when executed by the at least one processor 210 or 120, the electronic device 101 to, based on at least one of a property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 or a property of the user's input, provide feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 corresponding to the user's input. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, change a sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 according to a direction crossing a screen display area 235 of the 3D display 230 or 160.

In the electronic device 101 according to an embodiment, the 3D display 230 or 160 may include a lenticular lens 510 or a parallax barrier 520 disposed in front of the screen display area 235 to induce the user to experience binocular disparity.

The electronic device 101 according to an embodiment may further include at least one sensor 240 or 176 configured to measure positions of eyes of the user. The instructions may cause, when executed by the at least one processor 210 or 120, the electronic device 101 to obtain, from the at least one sensor 240 or 176, the positions of the eyes of the user. The instructions may cause, when executed by the at least one processor 210 or 120, the electronic device 101 to, as at least part of the displaying the stereoscopic screen 230 or 160, display the stereoscopic screen corresponding to the positions of the user's eyes.

In the electronic device 101 according to an embodiment, the instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, in response to the user's input, increase the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 by moving the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a first direction along the direction crossing the screen display area 235, or decrease the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 by moving the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a second direction opposite to the first direction.

In the electronic device 101 according to an embodiment, the user's input may be a touch input or a proximity input generated corresponding to the screen display area 235 of the 3D display 230 or 160. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, when decreasing the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, move a position of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a plane of the screen display area 235.

In the electronic device 101 according to an embodiment, the user's input may be a touch input or a proximity input generated corresponding to the screen display area 235 of the 3D display 230 or 160. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, when decreasing the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, apply a specific effect to at least a part, overlapped with the touch input or the proximity input, of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500.

In the electronic device 101 according to an embodiment, the instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, apply a specific effect corresponding to a change of the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500.

In the electronic device 101 according to an embodiment, the instructions may cause, when executed by the at least one processor 210 or 120, the electronic device 101 to, based on the property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, identify that the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is in an inactive state. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, increase the sense of the depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in response to the user's input

In the electronic device 101 according to an embodiment, the instructions may cause, when executed by the at least one processor 210 or 120, the electronic device 101 to, based on the property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, identify a state in which at least one of selecting, moving, or copying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is impossible. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a first direction or a second direction along the direction crossing the screen display area 235 in response to the user's input, or move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 to a position before being moved along the direction crossing the screen display area 235.

In the electronic device 101 according to an embodiment, the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be a window of scrollable or slidable content. The instructions may cause, when executed by the at least one processor 210 or 120, the electronic device 101 to, based on the property of the user's input, identify a state in which scrolling or sliding of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is no longer possible. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, move at least a part of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 by a distance proportional to a movement amount of the user's input along the direction crossing the screen display area 235.

In the electronic device 101 according to an embodiment, the instructions may cause, when executed by the at least one processor 210 or 120, the electronic device 101 to, based on the property of the user's input, identify a state in which at least one of manipulating, maximizing, or minimizing of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is impossible. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a first direction or a second direction along the direction crossing the screen display area 235, in response to the user's input.

In the electronic device 101 according to an embodiment, the instructions may cause, when executed by the at least one processor 210 or 120, the electronic device 101 to, based on the property of the user's input, identify a state in which moving the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is no longer possible. The instructions may cause, when executed by the at least one processor 210 or 120, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, move at least a part of a screen displayed in a background of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a first direction or a second direction along the direction crossing the screen display area 235, in response to the user's input.

A method of operating the electronic device 101 according to an example embodiment may include an operation 2630 of displaying a stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a 3D display 230 or 160. The method of operating the electronic device 101 according to an example embodiment may include an operation 2650 of obtaining a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The method of operating the electronic device 101 according to an example embodiment may include an operation 2680 of, based on at least one of a property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 or a property of the user's input, providing feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 corresponding to the user's input. The operation 2680 of providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may include an operation of changing a sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 according to a direction crossing a screen display area 235 of the 3D display 230 or 160.

In the method of operating the electronic device 101 according to an embodiment, the user's input may be a touch input or a proximity input generated corresponding to the screen display area 235 of the 3D display 230 or 160. The method of operating the electronic device 101 according to an embodiment may include, in the operation 2680 of providing the feedback to the object, when the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 decreases, an operation 2690 of moving a position of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a plane of the screen display area (235) or applying (2690) a predetermined effect to at least part of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 overlapping the touch input or the proximity input.

The method of operating the electronic device 101 according to an embodiment may further include an operation 2670 of, based on a property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, identifying that the input for the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is in an inactive state.

In the method of operating the electronic device 101 according to an embodiment, the operation 2680 of providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may increase the sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in response to the user's input.

The method of operating the electronic device 101 according to an embodiment may further include an operation 2670 of, based on the property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, identifying a state in which at least one of selecting, moving, or copying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is impossible. In the method of operating the electronic device 101 according to an embodiment, the operation 2680 of providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may move the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a first direction or a second direction along the direction crossing the screen display area 235 in response to the user's input, or move the object to a position before being moved along the direction crossing the screen display area 235.

In the method of operating the electronic device 101 according to an embodiment, the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be a window of scrollable or slidable content. The method of operating the electronic device 101 according to an embodiment may further include an operation 2670 of, based on the property of the user's input, identifying a state in which scrolling or sliding of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 is no longer possible. In method of operating the electronic device 101 according to an embodiment, the operation 2680 of providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may move at least a part of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 by a distance proportional to a movement amount of the user's input along the direction crossing the screen display area 235.

A non-transitory computer-readable storage medium configured to store one or more programs according to an example embodiment may include an operation 2630 of displaying a stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a 3D display 230 or 160, based on execution of an application. The method of operating the electronic device 101 according to an example embodiment may include an operation 2650 of obtaining a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The storage medium according to an embodiment may include an operation 2680 of, based on at least one of a property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 or a property of the user's input, providing feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 corresponding to the user's input. The storage medium according to an embodiment may include an operation 2680 of, based on identification that output of the predetermined response is impossible, moving the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 in a depth direction of the 3D display 230 or 160. The operation 2680 of providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may include an operation of changing a sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 according to a direction crossing a screen display area 235 of the 3D display 230 or 160.

The electronic device 101 according to an example embodiment may include a 3D display 230 or 160 capable of displaying a stereoscopic screen and at least one processor 210 or 120. The instructions may cause, when executed by the at least one processor 210 or 120, the electronic device 101 to display the stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on the 3D display 230 or 160. At least a port of the objects 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be displayed such that a sense of depth according to the direction that crosses the screen display area 235 of the 3D display 230 or 160 is reduced than the screen display area 235. The instructions may cause, when executed by the at least one processor 210 or 120, the electronic device 101 to obtain a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The user's input may be a touch input or a proximity input generated corresponding to the screen display area 235. The instructions may cause, when executed by the at least one processor 210 or 120, the electronic device 101 to, based on the user's input, change a property related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a plane of the screen display area 235.

In the electronic device 101 according to an embodiment, the instructions may cause, when executed by the at least one processor 210 or 120, the electronic device 101 to, as at least part of the operation of changing the property related to displaying of the object (e.g., one or more of 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500), move a position of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a plane of the screen display area 235.

In the electronic device 101 according to an embodiment, the instructions may cause, when executed by the at least one processor 210 or 120, the electronic device 101 to, as at least part of the operation of changing the property related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, apply a specific effect to at least a part, overlapped with the touch input or the proximity input, of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500.

A method of operating the electronic device 101 according to an example embodiment may include an operation 2710 of displaying a stereoscopic screen including an object (e.g., one or more of 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500) on a 3D display (e.g., 230 or 160). At least a port of the objects 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 may be displayed such that a sense of depth according to the direction that crosses the screen display area 235 of the 3D display 230 or 160 is reduced than the screen display area 235. The method of operating the electronic device 101 according to an example embodiment may include an operation 2730 of obtaining a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The user's input may be a touch input or a proximity input generated corresponding to the screen display area 235. The method of operating the electronic device 101 according to an embodiment may include an operation 2790 of changing a property related to displaying of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, based on the user's input. “Based on” as used herein covers based at least on. Likewise, “on the basis of” as used herein covers based at least on.

In a computer-readable storage medium 130 configured to store instructions according to an example embodiment, the instructions may cause, when executed by the at least one processor 210 or 120, the electronic device 101 to display a stereoscopic screen including an object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 on a displayable 3D display 230 or 160. The instructions may cause, when executed by the at least one processor 210 or 120, the electronic device 101 to obtain a user's input corresponding to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The instructions may cause, when executed by the at least one processor 210 or 120 of the electronic device 101, the electronic device 101 to, based on at least one of a property of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 or a property of the user's input, provide 2670 feedback corresponding to the user's input to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500. The instructions may cause, when executed by the at least one processor 210 or 120 of the electronic device 101, the electronic device 101 to, as at least part of the providing the feedback to the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500, change a sense of depth of the object 610, 640, 730, 810, 820, 830, 800, 930, 1030, 1130, 1200, 1210, 1310, 1320, 1400, 1500, 1600, 1610, 1620, 1730, 1810, 1930, 2030, 2110, 2120, 2210, 2310, 2320, or 2500 according to a direction crossing a screen display area 235 of the 3D display 230 or 160.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an example embodiment, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s). Thus, for example, “connected” as used herein covers both direct and indirect connections.

As used in connection with an example embodiment, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120, comprising processing circuitry) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an example embodiment may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions;
a three-dimensional (3D) display configured to display a stereoscopic screen; and
at least one processor comprising processing circuitry,
wherein the instructions, when executed by the at least one processor individually or collectively, cause the electronic device to:
display the stereoscopic screen including an object on the 3D display;
obtain a user's input corresponding to the object;
based on a property of the object and/or a property of the user's input, provide feedback to the object corresponding to the user's input; and
as at least part of the providing the feedback to the object, change a sense of depth of the object according to a direction crossing a screen display area of the 3D display.

2. The electronic device according to claim 1,
wherein the 3D display includes at least one of a lenticular lens or a parallax barrier disposed in front of the screen display area configured to induce binocular disparity of the user.

3. The electronic device according to claim 1, further comprising at least one sensor configured to detect positions of eyes of the user,
wherein the instructions cause the electronic device to:
obtain, based on information from the at least one sensor, the positions of the eyes of the user; and
as at least part of the displaying the stereoscopic screen on the 3D display, display the stereoscopic screen corresponding to the positions of the user's eyes.

4. The electronic device according to claim 1, wherein the instructions cause the electronic device to:
as at least part of the providing the feedback to the object, in response to the user's input, increase the sense of depth of the object by moving the object in a first direction along the direction crossing the screen display area, and/or decrease the sense of depth of the object by moving the object in a second direction opposite to the first direction.

5. The electronic device according to claim 1,
wherein the user's input is a touch input and/or a proximity input generated corresponding to the screen display area of the 3D display, and
wherein the instructions cause the electronic device to:
as at least part of the providing the feedback to the object, when decreasing the sense of depth of the object, move a position of the object on a plane of the screen display area.

6. The electronic device according to claim 1,
wherein the user's input is a touch input and/or a proximity input generated corresponding to the screen display area of the 3D display, and
wherein the instructions cause the electronic device to:
as at least part of the providing the feedback to the object, when decreasing the sense of depth of the object, apply a specific effect to at least a part, overlapped with the touch input or the proximity input, of the object.

7. The electronic device according to claim 1, wherein the instructions cause the electronic device to:
as at least part of the providing the feedback to the object, apply a specific effect corresponding to a change of the sense of depth to the object.

8. The electronic device according to claim 1, wherein the instructions cause the electronic device to:
based on the property of the object, identify that the object is in an inactive state; and
as at least part of the providing the feedback to the object, increase the sense of the depth of the object in response to the user's input.

9. The electronic device according to claim 1, wherein the instructions cause the electronic device to:
based on the property of the object, identify a state in which at least one of selecting, moving, or copying of the object is difficult and/or impossible; and
as at least part of the providing the feedback to the object, move the object in a first direction or a second direction along the direction crossing the screen display area in response to the user's input, or move the object to a position before being moved along the direction crossing the screen display area.

10. The electronic device according to claim 1,
wherein the object comprises a window of scrollable and/or slidable content, and
wherein the instructions cause the electronic device to:
based on the property of the user's input, identify a state in which scrolling and/or sliding of the object is no longer possible; and
as at least part of the providing the feedback to the object, move at least a part of the object by a distance proportional to a movement amount of the user's input along the direction crossing the screen display area.

11. The electronic device according to claim 1, wherein the instructions cause the electronic device to:
based on the property of the user's input, identify a state in which at least one of manipulating, maximizing, or minimizing of the object is difficult and/or impossible; and
as at least part of the providing the feedback to the object, move the object in a first direction or a second direction along the direction crossing the screen display area, in response to the user's input.

12. The electronic device according to claim 1, wherein the instructions cause the electronic device to:
based on the property of the user's input, identify a state in which moving the object is no longer possible; and
as at least part of the providing the feedback to the object, move at least a part of a screen displayed in a background of the object in a first direction or a second direction along the direction crossing the screen display area, in response to the user's input.

13. A method of operating an electronic device, the method comprising:
displaying a stereoscopic screen and/or image including an object on a 3D display;
obtaining a user's input corresponding to the object; and
based on at least one of a property of the object and/or a property of the user's input, providing feedback corresponding to the user's input to the object,
wherein the providing of the feedback to the object comprises changing a sense of depth of the object according to a direction crossing a display area of the 3D display.

14. The method according to claim 13, wherein the user's input is a touch input or a proximity input generated corresponding to the display area of the 3D display, and
wherein the providing of the feedback to the object comprises, when decreasing the sense of depth of the object, moving a position of the object on a plane of the display area and/or applying a predetermined effect to at least part, overlapping the touch input or the proximity input, of the object.

15. The method according to claim 13, further comprising:
based on the property of the object, identifying that the object is in an inactive state,
wherein the providing the feedback to the object comprises increasing the sense of the depth of the object in response to the user's input.

16. The method according to claim 13, further comprising:
based on the property of the object, identifying a state in which at least one of selecting, moving, or copying of the object is impossible,
wherein the providing the feedback to the object comprises moving the object in a first direction and/or a second direction along the direction crossing the display area in response to the user's input, and/or move the object to a position before being moved along the direction crossing the display area.

17. The method according to claim 13,
wherein the object comprises a window of scrollable and/or slidable content,
wherein the method comprises: based on the property of the user's input, identify a state in which scrolling and/or sliding of the object is no longer possible, and
wherein the providing the feedback to the object comprises moving at least a part of the object by a distance proportional to a movement amount of the user's input along the direction crossing the display area.

18. The method according to claim 13, further comprising:
based on the property of the user's input, identifying a state in which at least one of manipulating, maximizing, or minimizing of the object is impossible,
wherein the providing the feedback to the object comprises moving the object in a first direction and/or a second direction along the direction crossing the display area, in response to the user's input.

19. The electronic device according to claim 1, further comprising:
based on the property of the user's input, identifying a state in which moving the object is no longer possible,
wherein the providing the feedback to the object comprises moving at least a part of a screen displayed in a background of the object in a first direction and/or a second direction along the direction crossing the display area, in response to the user's input.

20. A non-transitory computer-readable storage medium storing instructions, the instructions being configured to, when executed individually or collectively by at least one processor of an electronic device, cause an electronic device to:
display a stereoscopic screen and/or image including an object on a 3D display;
obtain a user's input corresponding to the object;
based on at least one of a property of the object and/or a property of the user's input, provide feedback corresponding to the user's input to the object; and
as at least part of the providing the feedback to the object, change a sense of depth of the object according to a direction crossing a display area of the 3D display.
